(19) United States
(12) Patent Application Publication
(10) Pub. No.: US 2026/0292938 A1
(43) Pub. Date: Sep. 24, 2026

(54) COMBINABLE HAND WARMER

(71) Applicant: Guangdong Aoyun Technology Co., Ltd., Huizhou (CN)

(72) Inventor: Xueping Zhu, Huizhou (CN)

(21) Appl. No.: 19/686,875

(22) Filed: May 25, 2026

Related U.S. Application Data
(63) Continuation-in-part of application No. 19/214,071, filed on May 21, 2025.
(63) Continuation-in-part of application No. 18/680,265, filed on May 31, 2024.
Application No. 18/680,265 is a continuation-in-part of application No. 18/514,327, filed on Nov. 20, 2023, now Pat. No. 12,115,099.
Application No. 18/514,327 is a continuation-in-part of application No. 17/967,744, filed on Oct. 17, 2022, now Pat. No. 11,916,334.

(30) Foreign Application Priority Data
Aug. 5, 2022 (CN) 202222063218.4
Mar. 31, 2025 (CN) 202520596895.3
May 12, 2025 (CN) 202520933035.4

(51) Int. Cl. H05B 3/06

(52) U.S. Cl. CPC H05B 3/06

(57) ABSTRACT

A combinable hand warmer includes a first hand warmer unit and a second hand warmer unit. The first hand warmer unit is provided with the first connecting portion. The second hand warmer unit is provided with the second connecting portion. The first connecting portion and the second connecting portion are detachably connected, so that the first hand warmer unit and the second hand warmer unit are combined into a whole. Each of the first hand warmer unit and the second hand warmer unit is plate-shaped and includes a width, length, and thickness, the thickness being less than the length and the width of the respective hand warmer unit, and the first hand warmer unit and the second hand warmer unit are combined into a whole by stacking in an up and down manner along a direction of the thickness.

### CROSS-REFERENCE TO RELATED APPLICATIONS

This application is a Continuation-in-Part of the U.S. application Ser. No. 18/680,265, filed on May 31, 2024, and entitled "COMBINED TYPE HAND WARMER", now pending, which is a Continuation-in-Part of the U.S. application Ser. No. 18/514,327, filed on Nov. 20, 2023, now patented, and the US 18/514,327 is a Continuation-in-Part of the U.S. application Ser. No. 17/967,744, filed on Oct. 17, 2022, now patented, which claims a priority of Chinese Patent Application No. 202222063218.4, filed on Aug. 5, 2022; and this application is also a Continuation-in-Part of the U.S. application Ser. No. 19/214,071, filed on May 21, 2025, and entitled "HAND WARMER", now pending, which claims priorities of Chinese Patent Application No. 2025205968953, filed on Mar. 31, 2025, and Chinese Patent Application No. 2025209330354, filed on May 12, 2025, the entire disclosures of which are incorporated herein by reference.

### TECHNICAL FIELD

The present disclosure relates to the field of hand warmers, and particularly, to a combinable hand warmer.

### BACKGROUND

Hand warmers, as a convenient heating device, are widely popular in cold seasons. However, existing hand warmers primarily suffer from two technical shortcomings: on one hand, most hand warmers on the market currently use plastic casings for heat conduction, plastic has inferior thermal conductivity and heat resistance compared to materials like metal, failing to meet users' desired heating temperatures and resulting in slower heating speeds, this increases waiting time and limits the heating effect, to improve thermal efficiency, some solutions attempt to incorporate metal materials, but structural assembly issues often arise between metal components and plastic casings, making it difficult to achieve efficient and stable integration; On the other hand, currently available hand warmers—whether dual-sided or single-sided heating—typically form an irreparable monolithic structure, suitable only for warming one hand or a single body part, they struggle to simultaneously warm both hands or multiple independent body areas, especially when users need to perform different actions with their hands or require separate heating for multiple body parts, existing hand warmers often fail to meet these usage demands.

### SUMMARY

In order to overcome the shortcomings of the prior art, the present disclosure provides a hand warmer that can be used to warm the two hands/multiple body parts simultaneously and is convenient for users to carry.

The technical solution adopted by the present disclosure to solve the technical problem is as follows.

A combinable hand warmer includes a first hand warmer unit and a second hand warmer unit, wherein the first hand warmer unit includes a first outer surface and a first connecting inner surface opposite to the first outer surface; the second hand warmer unit includes a second outer surface and a second connecting inner surface opposite to the second outer surface; the first connecting inner surface includes a first connecting portion; the second connecting inner surface includes a second connecting portion; and the first connecting portion and the second connecting portion are magnetically connected to each other through a buckle or a plurality of magnetic components; and to connect the first connecting inner surface to the second connecting inner surface, the first hand warmer unit and the second hand warmer unit are combined into a whole.

Wherein each of the first hand warmer unit and the second hand warmer unit is plate-shaped and comprises a width, length, and thickness, the thickness being less than the length and the width of the respective hand warmer unit, and the first hand warmer unit and the second hand warmer unit are combined into a whole by stacking in an up and down manner along a direction of the thickness; wherein a first outer surface of the first hand warmer unit and a second outer surface of the second hand warmer unit are each defined by their respective length and width, each serving as a complete warming surface; whereby the combination of the first hand warmer unit and the second hand warmer unit provides a total warming surface area comprised of the first and second outer surfaces, the portion of each outer surface configured to contact a user's palm remaining substantially the same whether the units are attached or detached.

The present disclosure has the beneficial effects: a combinable hand warmer is provided, wherein the first hand warmer unit and the second hand warmer unit are detachably connected in the thickness direction (the first metal heat conduction shell is set in the thickness direction of the shell) through a first connecting portion and a second connecting portion (buckle or magnetic component). When the user needs to use both hands or multiple body parts for heating respectively, the first hand warmer unit can be separated from the second hand warmer unit and used separately; When users only need to provide heating for one hand or one body part, or two hands together, they can be combined into a block like whole, thereby doubling the heating area of the hand warmer for a single body part without increasing the width (increasing the width will result in inability to hold and energy waste), significantly improving the heating effect, and also facilitating users to choose combination or separate carrying and storage according to the usage scenario, greatly expanding the application scope. The first metal heat conduction shell has superior thermal conductivity and heat resistance compared to those plastic materials, which can achieve rapid heat conduction, effectively reduce heating waiting time, and make the hand warming effect better.

### BRIEF DESCRIPTION OF THE DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of a combinable hand warmer of the present disclosure.

FIG. 2 shows a first hand warmer unit and a second hand warmer unit of the combinable hand warmer of FIG. 1 are separated.

FIG. 3 shows another view of FIG. 2.

FIG. 4 is a cross sectional view cut away along a first connecting portion and a second connecting portion.

FIG. 5 is an enlarged view of the part A in FIG. 4.

FIG. 6 is a schematic structural diagram of a spinning slot and a spinning buckle.

FIG. 7 is a schematic structural diagram of a first magnetic member and a first magnetic fitting piece

FIG. 8 is a schematic structural diagram of a first magnetic member, a second magnetic member, a third magnetic member, a fourth magnetic member, a first magnetic fitting piece, a second magnetic fitting piece, a third magnetic fitting piece, and a fourth magnetic fitting piece

FIG. 9 is an exploded diagram of a first magnetic member, a second magnetic member, a third magnetic member, a fourth magnetic member, a first magnetic fitting piece, a second magnetic fitting piece, a third magnetic fitting piece, and a fourth magnetic fitting piece.

FIG. 10 is another exploded diagram of a first magnetic member, a second magnetic member, a third magnetic member, a fourth magnetic member, a first magnetic fitting piece, a second magnetic fitting piece, a third magnetic fitting piece, and a fourth magnetic fitting piece.

FIG. 11 is sectional view cut along a first magnetic member, a fourth magnetic member, a first magnetic fitting piece, and a fourth magnetic fitting piece.

FIG. 12 is an enlarged view of the C part in FIG. 11.

FIG. 13 is sectional view cut along a second magnetic member, a third magnetic member, a second magnetic fitting piece, and a third magnetic fitting piece.

FIG. 14 is another exploded diagram of a first magnetic member, a second magnetic member, a third magnetic member, a fourth magnetic member, a first magnetic fitting piece, a second magnetic fitting piece, a third magnetic fitting piece, and a fourth magnetic fitting piece.

FIG. 15 is another schematic structural diagram of a spinning slot and a spinning buckle.

FIG. 16 is still another schematic structural diagram of a spinning slot and a spinning buckle.

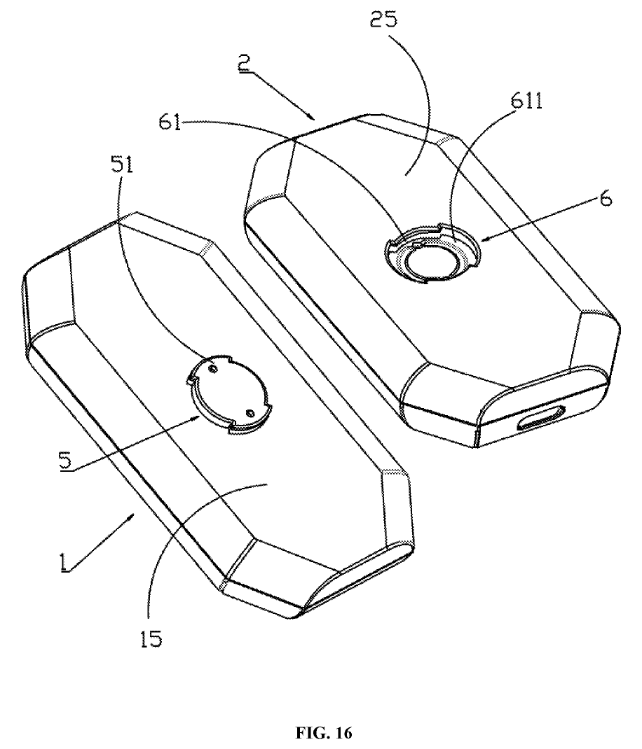

FIG. 17 is a three-dimensional diagram of a hand warmer unit according to the present disclosure.

FIG. 18 is another view of the hand warmer unit of FIG. 17.

FIG. 19 is a partially exploded view of a hand warmer unit according to a first embodiment of the present disclosure.

FIG. 20 is a partially exploded view of a hand warmer unit according to a second embodiment of the present disclosure.

FIG. 21 is a partially exploded view of a hand warmer unit according to a third embodiment of the present disclosure.

FIG. 22 is a partially exploded view of a hand warmer unit according to a fourth embodiment of the present disclosure.

FIG. 23 is another view of FIG. 22.

FIG. 24 is an enlarged view of a first shell of the hand warmer unit according to the present disclosure.

FIG. 25 is an exploded cross sectional view of the hand warmer unit of FIG. 17.

FIG. 26 is an enlarged view of the D part of FIG. 24.

FIG. 27 is a cross sectional view of the hand warmer unit of FIG. 22.

FIG. 28 is a three-dimensional diagram of a hand warmer unit according to a fifth embodiment of the present disclosure.

FIG. 29 is a cross sectional view of the hand warmer unit of FIG. 28.

FIG. 30 is a partially exploded view of a hand warmer unit according to a sixth embodiment of the present disclosure.

FIG. 31 is a system block diagram in an embodiment of a temperature control circuit for a hand warmer unit according to the present disclosure.

FIG. 32 is a circuit diagram of a heating unit and a temperature detection unit in an embodiment of a temperature control circuit for a hand warmer unit according to the present disclosure.

FIG. 33 is a circuit diagram of a charging unit in an embodiment of a temperature control circuit for a hand warmer unit according to the present disclosure.

FIG. 34 is a circuit diagram of a main control unit, a lighting unit and a button unit in an embodiment of a temperature control circuit for a hand warmer unit according to the present disclosure.

FIG. 35 is a circuit diagram of a battery in an embodiment of a temperature control circuit for a hand warmer unit according to the present disclosure.

### DETAILED DESCRIPTION OF THE EMBODIMENTS

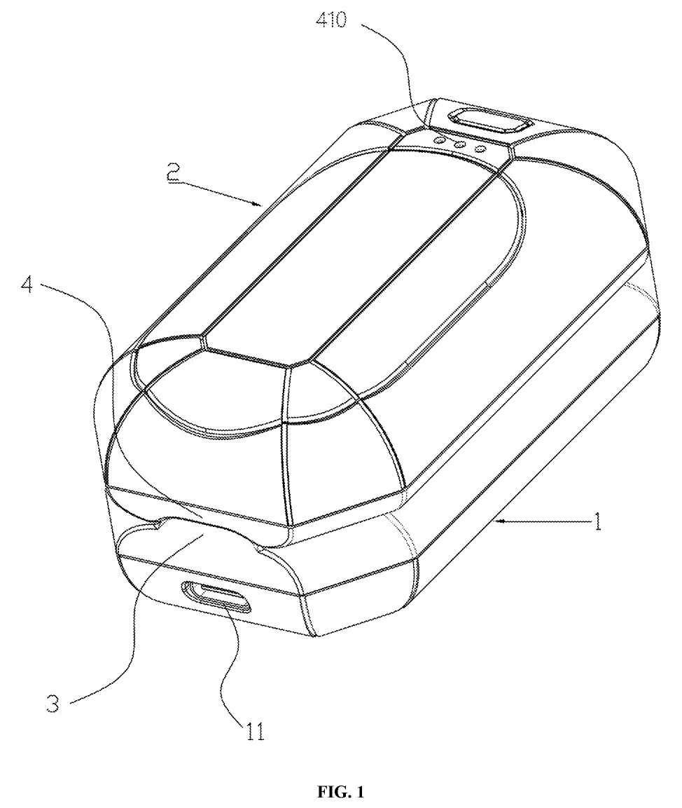

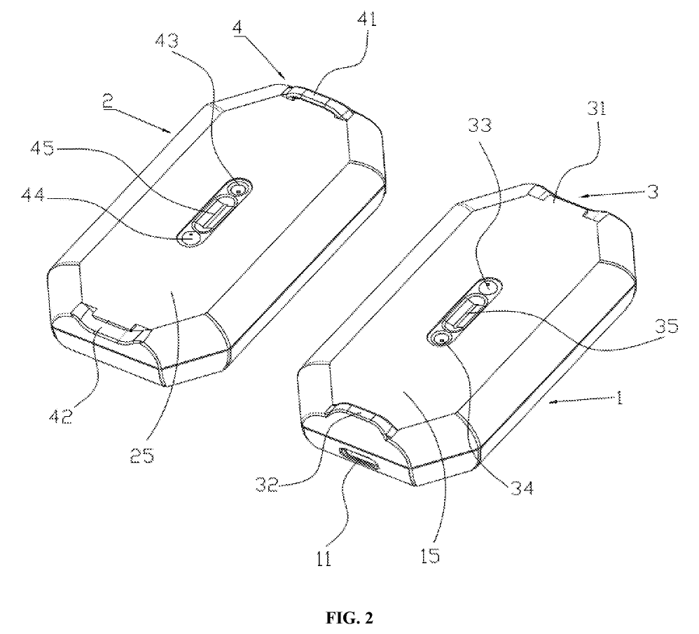

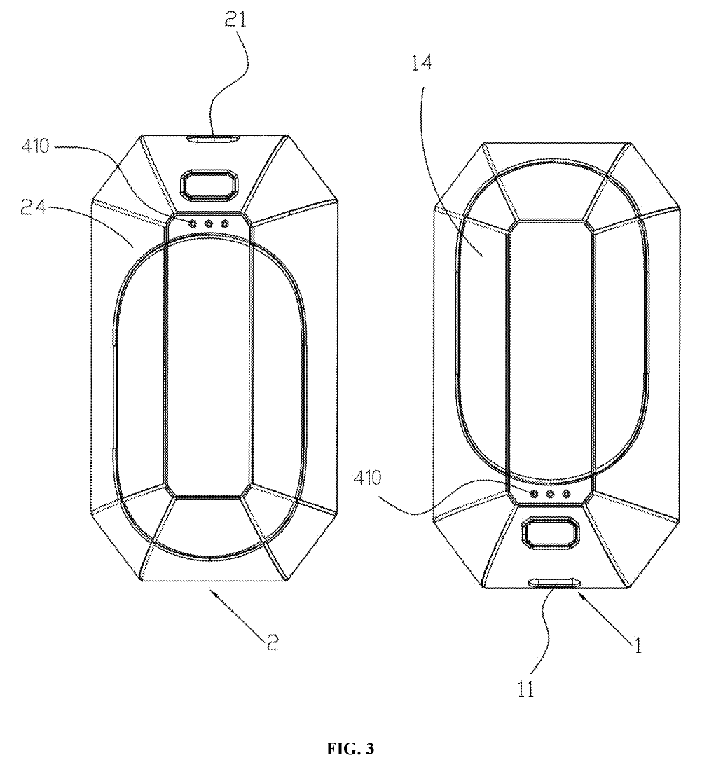

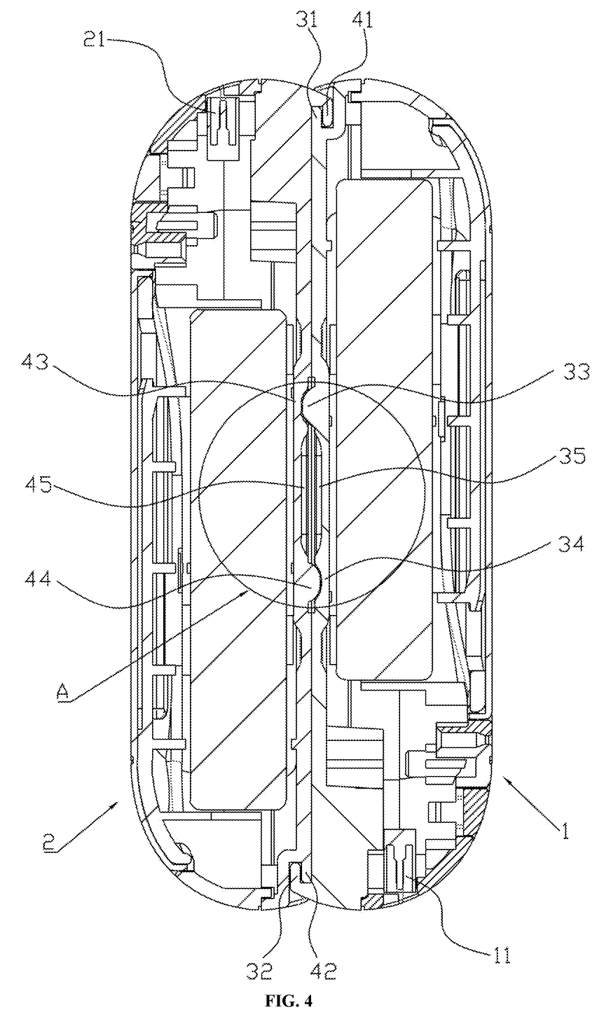

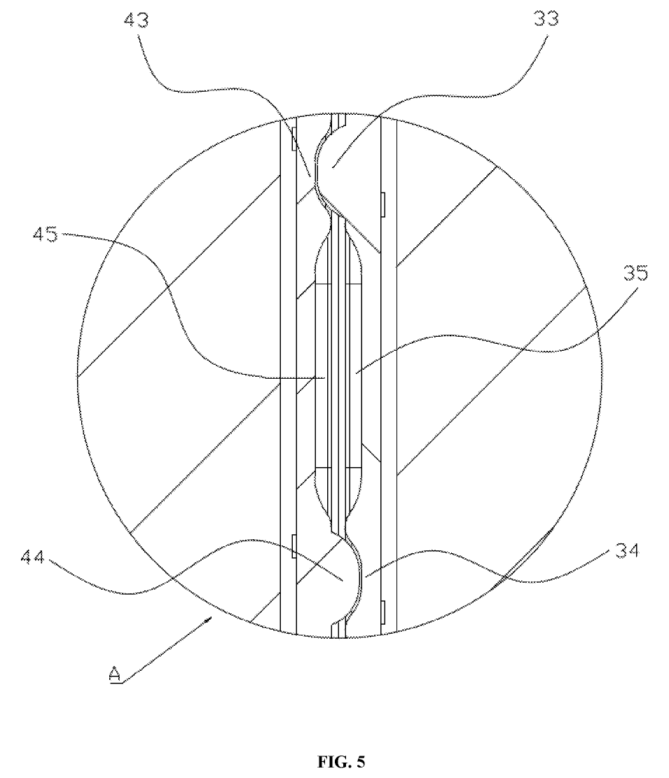

Referring to FIG. 1 to FIG. 5, a combinable hand warmer includes a first hand warmer unit 1 and a second hand warmer unit 2, wherein the first hand warmer unit 1 is provided with a first connecting portion 3; the second hand warmer unit 2 is provided with a second connecting portion 4; the first connecting portion 3 is detachably connected to the second connecting portion 4, so that the first hand warmer unit 1 and the second hand warmer unit 2 are combined into a whole with double-sided heating by stacking and combining in the thickness direction to form a compact structure suitable for gripping, and the combinable hand warmer do not increase a width relative to the first hand warmer unit 1 or the second hand warmer unit 2. Through the above structure, due to the first hand warmer unit 1 and the second hand warmer unit 2, the first hand warmer unit 1 is provided with the first connecting portion 3, and the second hand warmer unit 2 is provided with the second connecting portion 4; the first connecting portion 3 and the second connecting portion 4 are detachably connected, so that the first hand warmer unit 1 and the second hand warmer unit 2 are combined into a whole.

When a user needs to use one hand warmer unit to respectively warm the hands/multiple body parts, the first hand warmer unit 1 can be separated from the second hand warmer unit 2, so that the first hand warmer unit 1 and the second hand warmer unit 2 can be used for warming the two hands/multiple different body parts respectively. When a user only needs to use the hand warmer units to warm one hand/one body part, or two hands together, the first connecting portion can be connected to the second connecting portion to combine the first hand warmer unit 1 with the second hand warmer unit 2 into a whole, so as to enlarge a warming area of the hand warmer for one hand/one body part, or two hands together, and improve the warming effect. Furthermore, when a user needs to carry or store the hand warmer units, the user can select to separately carry and store the first hand warmer unit and the second hand warmer unit according to an actual situation, or select to combine the first hand warmer unit with the second hand warmer unit into a whole to satisfy the use in multiple scenarios by a user, which greatly improves the user experience.

In the combined state, the first hand warmer unit 1 and the second hand warmer unit 2 are stacked in an up and down manner to form a combination realizing bidirectional heat conduction, to greatly improve the heating efficiency. At the same time, the compact and ergonomic design ensures that the product can be easily grasped by users with one hand or held with both hands, making it convenient for users to use and improving portability and user experience. Each of the first hand warming unit 1 and the second hand warming unit 2 is plate-shaped and has a width, length, and thickness, where the thickness is less than the length and the width of the corresponding hand warming unit. The first outer surface 14 of the first hand warmer unit 1 and the second outer surface 24 of the second hand warmer unit 2 are defined by their respective lengths and widths, and each serves as a complete warming surface, therefore, the combination of the first hand warmer unit 1 and the second hand warmer unit 2 provides a total warming surface area composed of the first and second warming surfaces 14, 24. Regardless of whether the hand warmer unit 1, 2 is connected or separated, the parts of each outer surface 14, 24 that are configured to contact the user's palm remain basically consistent, making it easy for the user to grip.

In this embodiment, the first hand warmer unit 1 includes a first outer surface 14 and a first connecting inner surface 15 opposite to the first outer surface 14; the second hand warmer unit 2 includes a second outer surface 24 and a second connecting inner surface 25 opposite to the second outer surface 24; the first connecting inner surface 15 includes a first connecting portion 3; the second connecting inner surface 25 includes a second connecting portion 4; the first connecting portion 3 includes a first buckle portion; the second connecting portion 4 includes a first buckle fitting portion; the first buckle portion is detachably connected to the first buckle fitting portion, so that the first connecting inner surface 15 is buckled to the second connecting inner surface 25, and the first hand warmer unit 1 and the second hand warmer unit 2 are combined into a whole.

As shown in FIGS. 1-7 and 27, the first connecting portion 3 and the second connecting portion 4 are connected by a buckle and/or magnetic attraction to connect the first connecting inner surface 15 with the second connecting inner surface 25, the first hand warmer unit 1 and the second hand warmer unit 2 are combined into a whole.

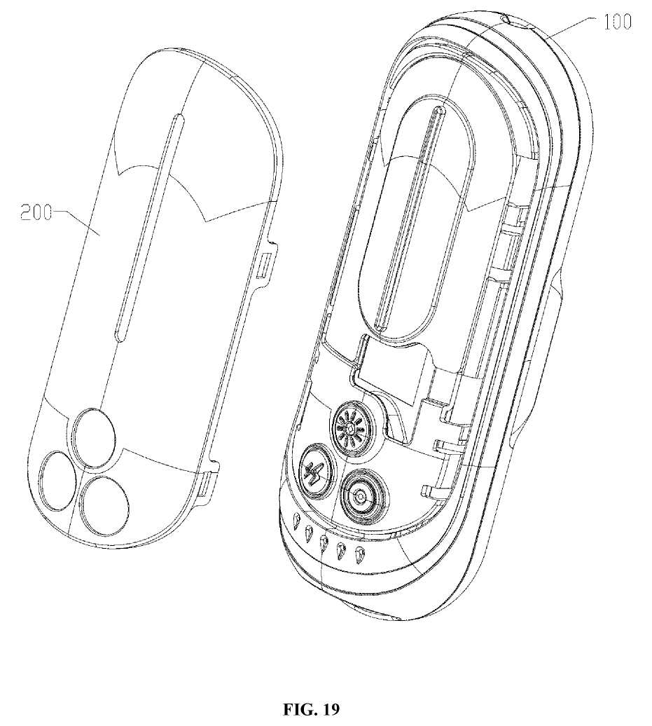

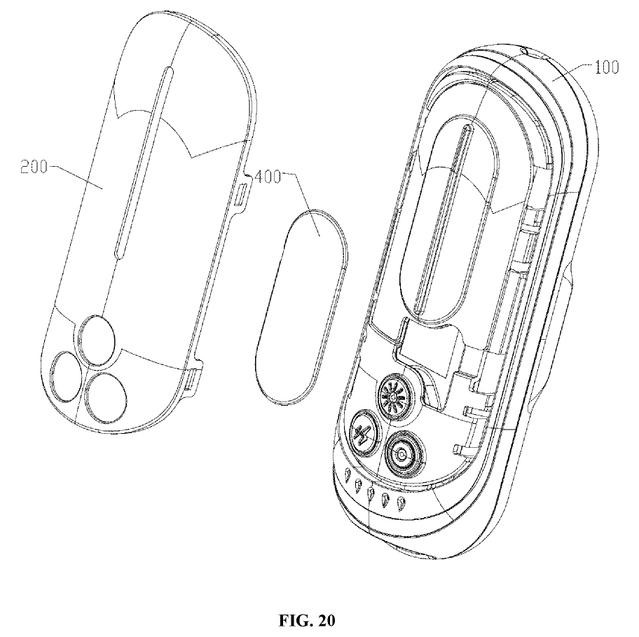

Referring to FIGS. 19, 20 and 27, in present embodiment, each of the first hand warmer unit 1 and the second hand warmer unit 2 includes a shell 100, a first metal heat conduction shell 200, and a circuit board 300. The shell 100 has an accommodating cavity 111. The first metal heat conduction shell 200 is in snap-in connection to the shell 100 and is located on an outer side of the shell 100 away from the accommodating cavity 111. In addition, the circuit board 300 is located in the accommodating cavity 111, is electrically connected to a heating element 400 and/or the first metal heat conduction shell 200, and is configured to output an electrical signal to the heating element 400 and/or the first metal heat conduction shell 200 to heat the heating element 400 and/or the first metal heat conduction shell 200.

The shell 100 is made of plastic material, a hardness of the shell 100 is lower than that of the first metal heat conduction shell 200; a thermal conductivity of the shell 100 is lower than that of the first metal heat conduction shell 200.

Referring to 20, 22 and 23, in one embodiment, the first metal heat conduction shell 200 can be used as a heating element. That is, the circuit board 300 is electrically connected to the first metal heat conduction shell 200, thereby applying an electrical signal to heat the first metal heat conduction shell 200, and the heating element 400 can be omitted. In another embodiment, the circuit board 300 is electrically connected to the heating element 400, thereby applying an electrical signal to heat the heating element 400. The heating element 400 can be a metal heating sheet, a flexible heating circuit board (such as a flexible circuit board with a heating line), or a heating film layer (such as a graphene heating film layer). The heating element 400 can be attached to an inner side of the first metal heat conduction shell 200 and directly conduct heat to the first metal heat conduction shell 200, or on the outer side of the shell 100 facing the first metal heat conduction shell 200. In another embodiment, the circuit board 300 can be electrically connected to the heating element 400 and the first metal heat conduction shell 200, for example, electrically connected to the first metal heat conduction shell 200 through the heating element 400, thereby applying an electrical signal to heat the heating element 400 and the first metal heat conduction shell 200 together.

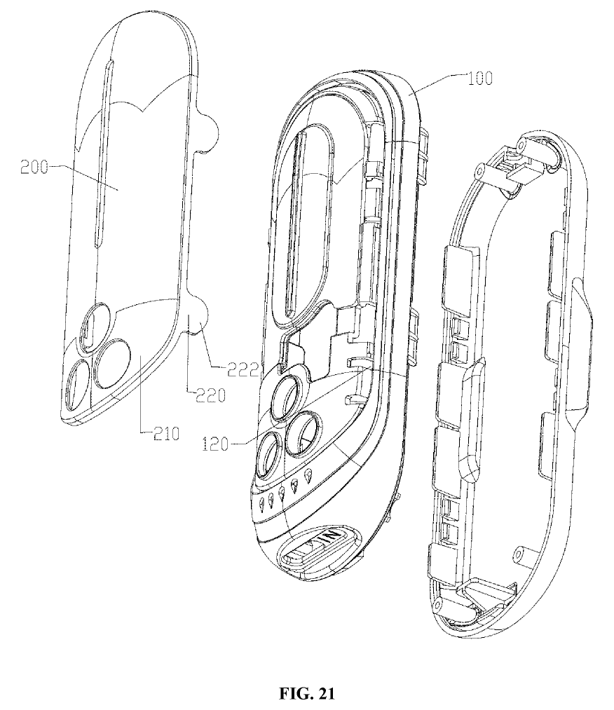

Referring to FIG. 21, in one embodiment, the first metal heat conduction shell 200 includes a metal plate 210 and at least one first fastener 220 connected to the metal plate 210. The at least one first fastener 220 is integrally formed with the metal plate 210. At least one second fastener 130 is provided on an inner side of the shell 100, and the at least one first fastener 220 is configured for clamping the at least one second fastener 130. It can be understood that the first metal heat conduction shell 200 uses the metal plate 210 for heat conduction to warm the hands of a user. Meanwhile, the at least one first fastener 220 is used for snap-in connection with the shell 100 of the hand warmer unit, making assembling simpler, more convenient, and faster, and improving assembling efficiency. Furthermore, the at least one first fastener 220 is integrally formed with the metal plate 210, a mold can be used for integrated production, thereby improving the yield of finished products, improving production efficiency, and facilitating large-scale production.

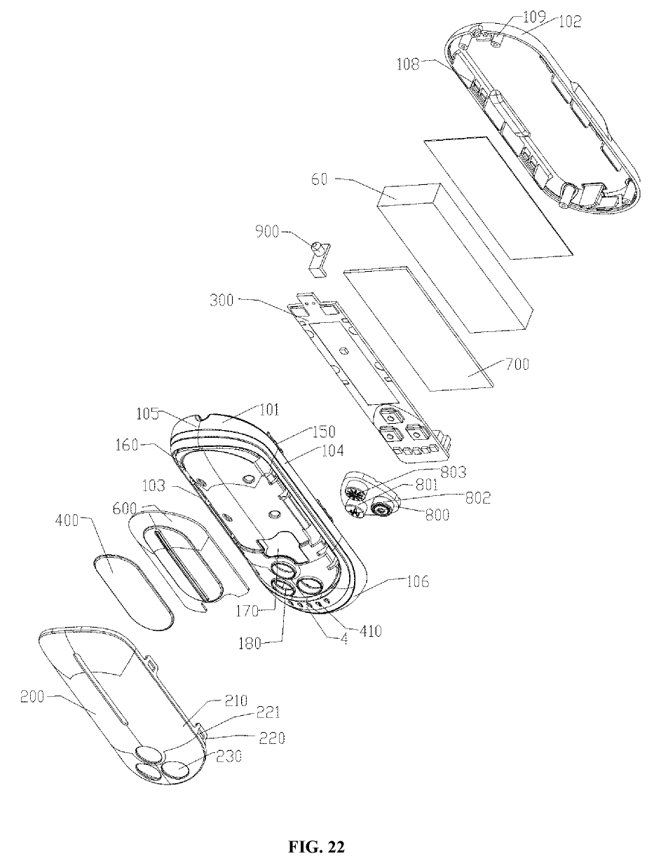

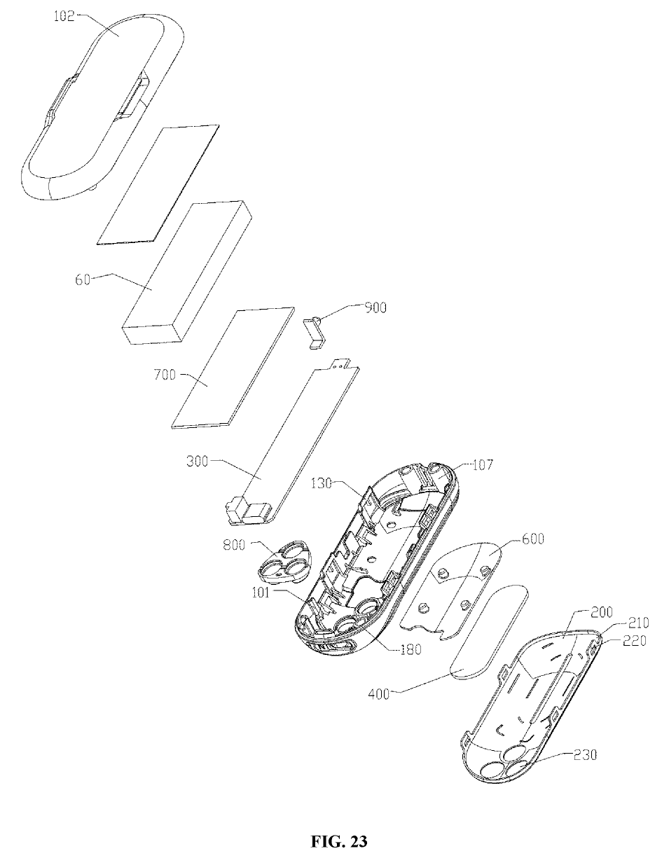

As shown in FIGS. 22-23, in another embodiment, the at least one first fastener 220 is bent and connected to the metal plate 210, and at least one second fastener 130 is also provided on the shell 100, the at least one first fastener 220 is clamped with the at least one second fastener 130 to fix the metal plate 210 to the shell 100, making the installation process simpler and easier to operate.

In another embodiment, the at least one first fastener 220 includes at least one metal sheet 222 that is in bent connection to the metal plate 210. The shell 100 includes at least one fixing hole 120. The at least one metal sheet 222 is bent and fixed in the at least one fixing hole 120 after passing through the at least one fixing hole 120. In this embodiment, during mounting of the first metal heat conduction shell 200, the metal sheet 222 of the at least one first fastener 220 can be inserted into the fixing hole 120 of the shell 100, and then the metal sheet 222 is bent to connect the metal plate 210 to the shell 100. By designing the at least one first fastener 220 that includes the at least one metal sheet 222 in bent connection to the metal plate 210, the mounting of the metal plate 210 and the shell 100 can be completed through insertion and bending operations, so that the mounting operation is more convenient and faster.

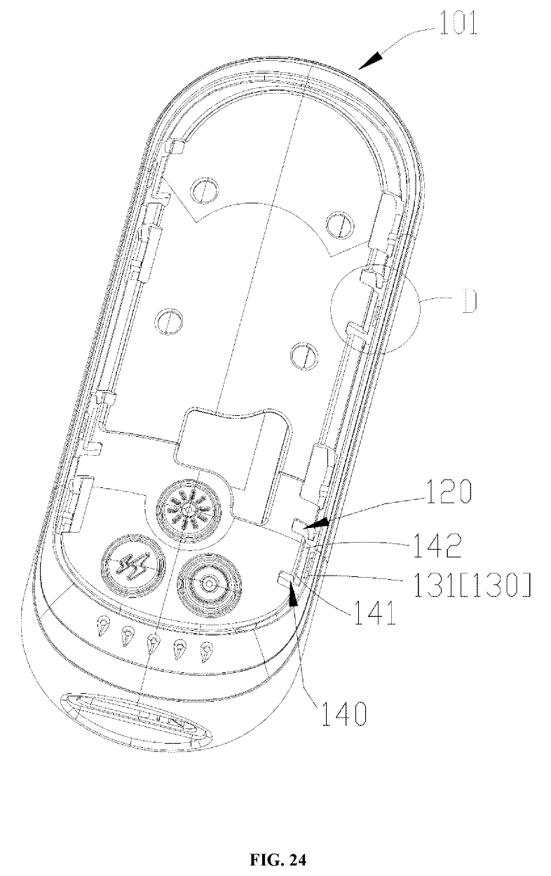

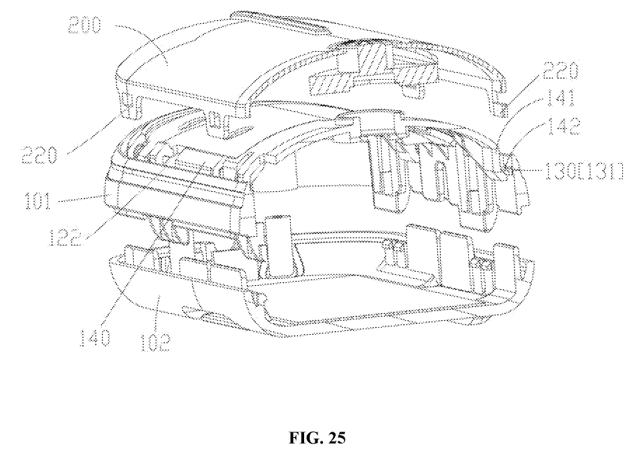

Referring to FIGS. 24-26, the shell 100 is provided with an elastic portion 140. Specifically, the shell 100 is also provided with a U-shaped fixing hole 120, which wraps around the elastic portion 140, so that one end of the elastic portion 140 is connected to the shell 100, and the other end forms a freely movable elastic end. The fixing hole 120 includes a main body 121 for the first fastener 220 to pass through, and two extension portions 122 respectively connected to both ends of the main body 121. When viewed from the projection along the thickness direction of the first metal heat conduction shell 200, both the extension portions 122 are located within the projection coverage range of the first metal heat conduction shell 200. The cantilever-liked elastic portion 140 is directly defined on the shell 100 through contour of the U-shaped fixed hole 120, utilizing the elasticity of the shell material itself to achieve automatic avoidance and reset of the buckle, simplifying the structure and eliminating the need for additional spring components. The combination design of the main body 121 and the extension portions 122 provides both a threading path for the buckle and sufficient deformation space for the elastic portion 140.

As shown in FIGS. 24-26, furthermore, an arc-shaped guide portion 141 is provided at one end of the elastic portion 140 facing the main body 121, and the arc-shaped guide portion 141 extends and transitions to form a groove portion 142 on the upper surface of the elastic portion 140; and the groove portion 142 is spaced apart from the second fastener 130 provided on the inner wall of the shell 100 to jointly define a locking space. During assembly, the first fastener 220 passes through the main body 121 and slides along the arc-shaped guide portion 141, forcing the elastic portion 140 to produce elastic retreat towards the inside of the shell 100 until the first fastener 220 is confined in the locking space, at this time, one side of the first fastener 220 is located within the groove portion 142, and the arc-shaped guide portion 141 contacts the first fastener 220, the contact force provided by the elastic portion 140 after elastic reset presses the first fastener 220 onto the second fastener 130. That is, during assembly of the first fastener 22 onto the second fastener 130, the first fastener 22 only needs to slide along the guide surface to automatically clamp without loosening; in addition, during disassembling, only reverse force is needed to squeeze the elastic portion to exit the first fastener 220, in this way, disassembly and maintenance are very convenient, and the assembly process is completed without the need for additional tools, further improving the efficiency of assembly and maintenance.

Specifically, referring to FIGS. 22-23, the at least one first fastener 220 includes a clamping slot 221 provided on the metal plate 210, and the at least one second fastener 130 includes a hook 131 corresponding to the clamping slot 221, which is fixed inside the clamping slot 221, in this way, by replacing traditional adhesives or simple screw connections with rigid buckles, the problem of loosening of metal and plastic heterogeneous parts due to different thermal expansion and contraction rates is effectively solved, ensuring the stability and surface smoothness of the first metal heat conduction shell 200 connection during its service life, and improving assembly efficiency.

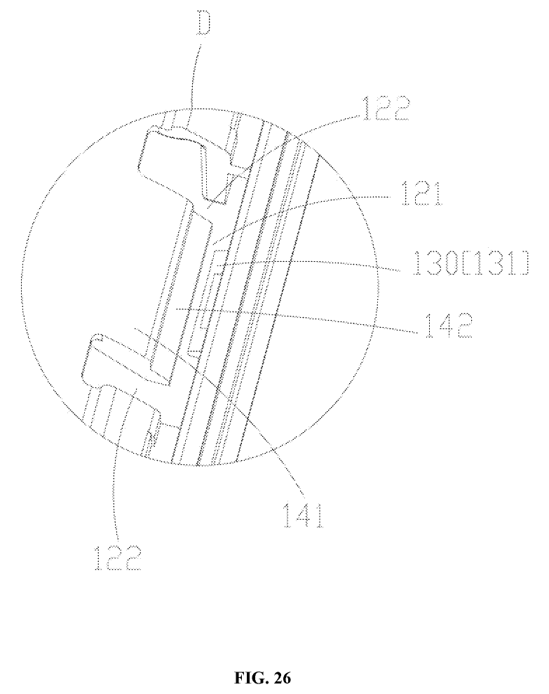

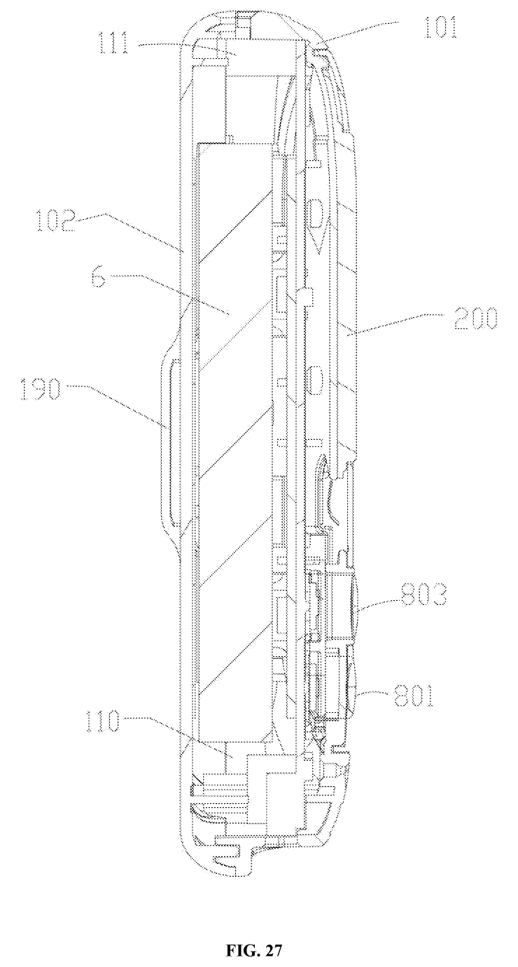

Furthermore, referring to FIGS. 26 and 27, the shell 100 includes a first shell 101 and a second shell 102, the first shell 101 and the second shell 102 are connected and enclosed to form the accommodating cavity 111. The first metal heat conduction shell 200 is arranged on one side of the first shell 101 away from the second shell 102. The first shell 101 has the at least one fixing hole 120 penetrating through the first shell 101. The at least one second fastener 130 is further arranged on one side of the first shell 101 that is enclosed into the accommodating cavity 111. By designing the first shell 101 and the second shell 102, relevant components can be placed into the accommodating cavity 111 during mounting, and then the first shell 101 and the second shell 102 can be mounted and connected, so that it is more convenient and easier to mount the hand warmer unit.

Furthermore, referring to FIGS. 21-24, a quantity of the at least one first fastener 220 and a quantity of the at least one second fastener 130 are plural. The plurality of first fasteners 220 are in corresponding snap-in connection with the plurality of second fasteners 130. The first shell 101 is further provided with a plurality of third fasteners 150. The second shell 102 is further provided with a plurality of fourth fasteners 108. The plurality of third fasteners 150 are in corresponding snap-fit connection with the plurality of fourth fasteners 108. The first shell 101 includes a first side edge 103 and a second side edge 104 that extend in a length direction and that are opposite to each other. The plurality of second fasteners 130 and the plurality of third fasteners 150 are staggered and are arranged on the first side edge 103 and the second side edge 104.

The first shell 101 further includes a third side edge 105 and a fourth side edge 106 that are connected between the first side edge 103 and the second side edge 104 and that are opposite to each other. The first shell 101 is provided with a plurality of first positioning members 107 adjacent to the third side edge 105 and the fourth side edge 106. The second shell 102 is provided with a plurality of second positioning members 109 corresponding to the plurality of first positioning members 107. The plurality of first positioning members 107 and the plurality of second positioning members 109 are in butting and positioning fit.

A surface of the shell 100 close to the first metal heat conduction shell 200 further has an accommodating slot 160 corresponding to the first metal heat conduction shell 200. The first metal heat conduction shell 200 is at least partially accommodated in the accommodating slot 160, so that an outer surface of the first metal heat conduction shell 200 is smoothly connected to a part of an outer surface of the shell 100 that is located on an outer side of the first metal heat conduction shell 200.

The shell 100 further has an opening 170. The first metal heat conduction shell 200 covers the opening 170 and is configured to be electrically connected to the circuit board 300 through a wire passing through the opening 170, so that the circuit board 300 heats the first metal heat conduction shell 200.

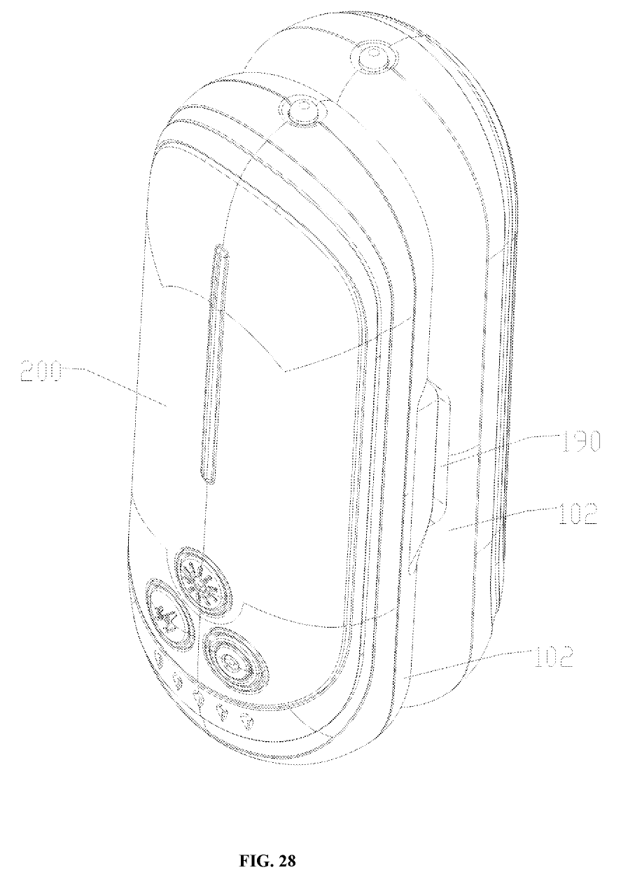

In another embodiment, referring to FIGS. 27-28, the shell 100 is provided with a detachable connector 190 on one side away from the first metal heat conduction shell 200. The detachable connector 190 of one hand warmer unit is configured to be detachably connected to another detachable connector 190 of another hand warmer unit, so that the hand warmer unit and the another hand warmer unit form a combinable hand warmer that is combined for use, or separated from each other for separate use. In this embodiment, the detachable connector 190 can be a sliding chute, there are two detachable connectors, the sliding chute of one hand warmer unit is slidably clamped with the sliding chute of another hand warmer unit to connect the two hand warmer units into a whole, so that the first metal heat conduction shells 200 of the two hand warmer units can both face outwards, and a user can use the two first metal heat conduction shells 200 to stay warm, in this way, assembling and disassembling operations are simple.

Referring to FIGS. 1 to 5, in some embodiments, the first connecting portion 3 is connected to the second connecting portion 4 through a buckle. The first connecting portion 3 further includes a second buckle portion; the second connecting portion 4 further includes a second buckle fitting portion. When the first buckle portion is detachably plugged into the first buckle fitting portion, the second buckle portion is detachably plugged into the second buckle fitting portion.

Specifically, the first buckle portion is a buckle or a buckle slot, and the first buckle fitting portion is a buckle slot or a buckle; when the first buckle portion is a buckle, the first buckle fitting portion is a buckle slot; when the first buckle portion is a buckle slot, the first buckle fitting portion is a buckle; the second buckle portion is a buckle or a buckle slot, and the second buckle fitting portion is a buckle slot or a buckle; when the second buckle portion is a buckle, the second buckle fitting portion is a buckle slot; and when the second buckle portion is a buckle slot, the second buckle fitting portion is a buckle.

In this embodiment, the first buckle portion is a first buckle 31, the first buckle fitting portion is a first buckle slot 41, and the first buckle 31 is detachably plugged into the first buckle slot 41. The second buckle portion is a second buckle slot 32, and the second buckle fitting portion is a second buckle 42. When the first buckle 31 is detachably plugged into the first buckle slot 41, the second buckle 42 is detachably plugged into the second buckle slot 32. Through the above structure, the structure is simple, the connection is stable, and the detachable connection between the first connecting portion and the second connecting portion is effectively achieved. Moreover, in this embodiment, the detachable connection between the first connecting portion and the second connecting portion can be further achieved by using a detachable connection mode such as male and female snappers and male and female hook and loop fasteners.

In this embodiment, also referring to FIGS. 1 to 5, the first connecting portion 3 further includes a first positioning column 33, and the second connecting portion 4 further includes a first positioning hole 43; and when the first positioning column 33 is located in the first positioning hole 43, the first buckle 31 is detachably plugged into the first buckle slot 41, and the second buckle 42 is detachably plugged into the second buckle slot 32. The first connecting portion 3 further includes a second positioning hole 34, and the second connecting portion 4 further includes a second positioning column 44; and when the first positioning column 33 is located in the first positioning hole 43 and the second positioning column 44 is located in the second positioning hole 34, the first buckle 31 is detachably plugged into the first buckle slot 41, and the second buckle 42 is detachably plugged into the second buckle slot 32. Specifically, the first connecting portion 3 further includes a first guide slot 35; the first positioning column 33 is located on an upper side of the first guide slot 35; the second positioning hole 34 is located on a lower side of the first guide slot 35; the second connecting portion 4 further includes a second guide slot 45; the first positioning hole 43 is located on an upper side of the second guide slot 45; the second positioning column 44 is located on a lower side of the second guide slot 45; and when the first positioning column 33 slides into the first positioning hole 43 along the second guide slot 45, and the second positioning column 44 slides into the second positioning hole 34 along the first guide slot 35, the first buckle 31 is detachably plugged into the first buckle slot 41, and the second buckle 42 is detachably plugged into the second buckle slot 32. Furthermore, the first buckle 31 is arranged on one side of the first hand warmer unit 1, and the second buckle slot 32 is arranged on the other side of the first hand warmer unit 1 in a manner of being symmetric to the first buckle; and the second buckle 42 is arranged on one side of the second hand warmer unit 2, and the first buckle slot 41 is arranged on the other side of the second hand warmer unit 2 in a manner of being symmetric to the second buckle.

Through the above structure, by the connection between the first positioning column 33 and the first positioning hole 43, and the connection between the second positioning column 44 and the second positioning hole 34, it can ensure that the first buckle 31 is fully plugged into the first buckle slot 41, and the second buckle 42 is fully plugged into the second buckle slot 32, so as to improve the stability of connection between the first hand warmer unit 1 and the second hand warmer unit 2. Furthermore, through the first guide slot 35, it can ensure that the second positioning column 44 slides quickly and accurately into the second positioning hole 34. Through the second guide slot 45, it can ensure that the first positioning column 33 slides quickly and accurately into the first positioning hole 43, so as to quickly and accurately plug the first buckle 31 into the first buckle slot 41, plug the second buckle 42 into the second buckle slot 32, and complete the connection between the first hand warmer unit 1 and the second hand warmer unit 2, so that the first hand warmer unit 1 and the second hand warmer unit 2 are combined into a whole.

Further, as the first positioning column 33 is located in the first positioning hole 43 and the second positioning column 44 is located in the second positioning hole 34, the first positioning column 33 can be prevented from sliding out of the first positioning hole 43, and the second positioning column 44 can be prevented from sliding out of the second positioning hole 34, thus preventing relative sliding between the first hand warmer unit 1 and the second hand warmer unit 2 and preventing the first hand warmer unit 1 from being separated from the second hand warmer unit 2. Further, when a user needs to separate the first hand warmer unit 1 from the second hand warmer unit 2, the user only needs to slide the first positioning column 33 out of the first positioning hole 43, slide the second positioning column 44 out of the second positioning hole 34, then slide the first buckle 31 out of the first buckle slot 41, and slide the second buckle 42 out of the second buckle slot 32, so as to complete the disassembling of the first hand warmer unit 1 and the second hand warmer unit 2. This facilitates the user to use the first hand warmer unit 1 and the second hand warmer unit 2 to warm multiple body parts. The first hand warmer unit 1 and the second hand warmer unit 2 can even be used separately by different people. Meanwhile, it is also convenient for a user to separately carry and store the first hand warmer unit 1 and the second hand warmer unit 2. Particularly, a user can carry the first hand warmer unit 1 and the second hand warmer unit 2 separately by putting them into pockets.

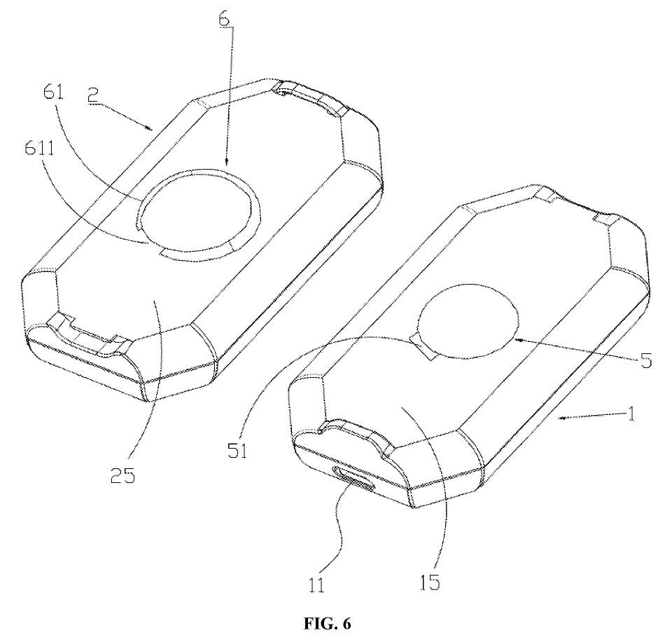

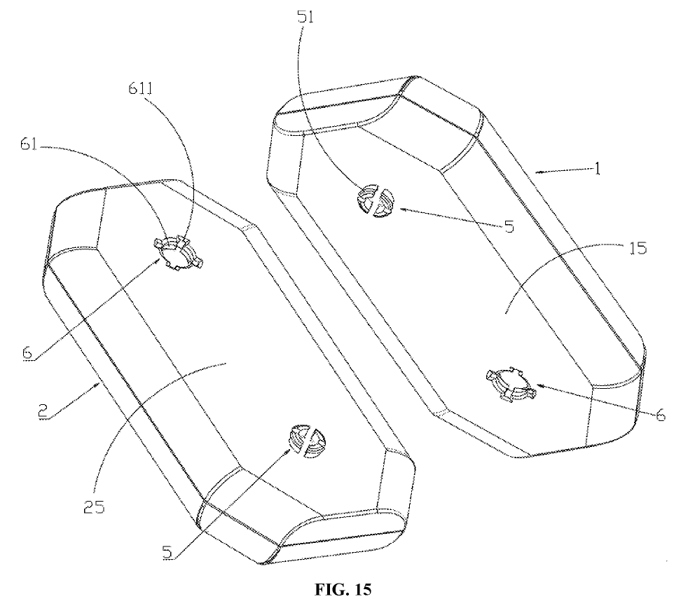

Referring to FIGS. 6 and 14-15, in some embodiments, the first buckle portion is a spinning buckle 5; the first buckle fitting portion is a spinning slot 6; and the spinning buckle 5 is detachably connected to the spinning slot 6. A stop convex block 51 is arranged on the spinning buckle 5; a stop edge 61 is arranged on the spinning slot 6; a notch 611 is arranged on the stop edge 61; the notch 611 is connected to the spinning slot 6; when the stop convex block 51 rotates with the spinning buckle 5 to the notch 611, the stop convex block 51 can be placed into the spinning slot 6 along with the spinning buckle 5 via the notch 611; and when stop convex block 51 is placed into the spinning slot 6 along with the spinning buckle 5 via the notch 611, the spinning buckle 5 is rotated to enable the stop convex block 51 to rotate to be staggered from the notch 611, so that the stop edge 61 stops the stop convex block 51 of the spinning buckle 5 in the spinning slot 6, and the first hand warmer unit 1 and the second hand warmer unit 2 are combined into a whole.

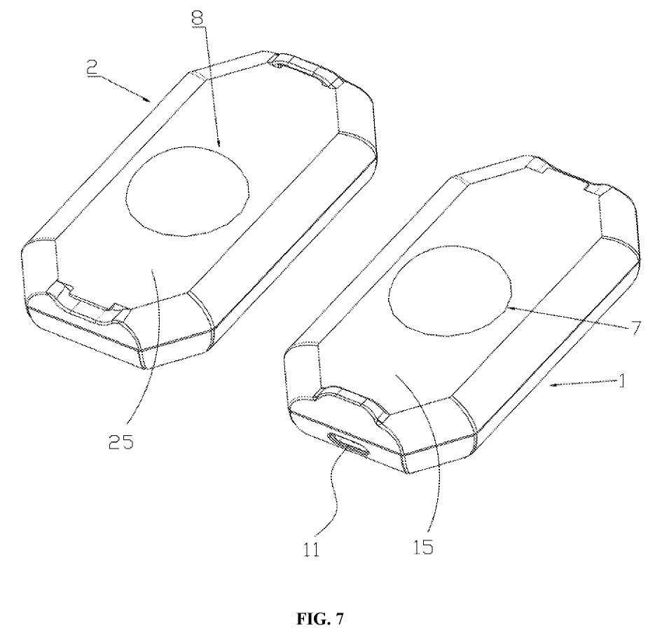

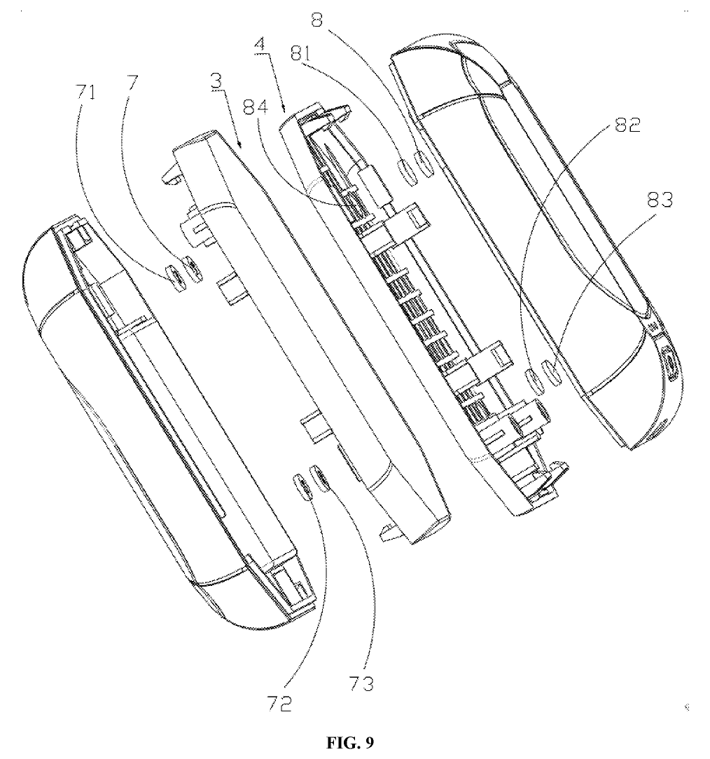

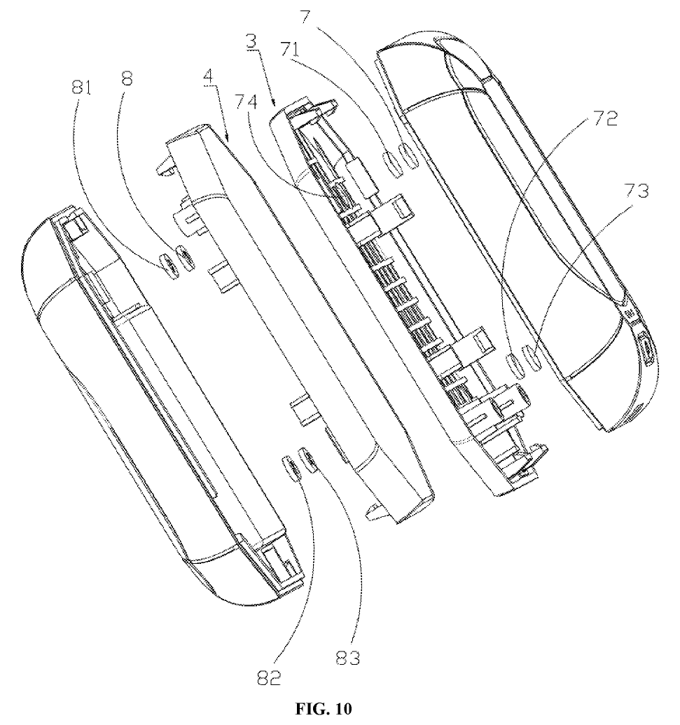

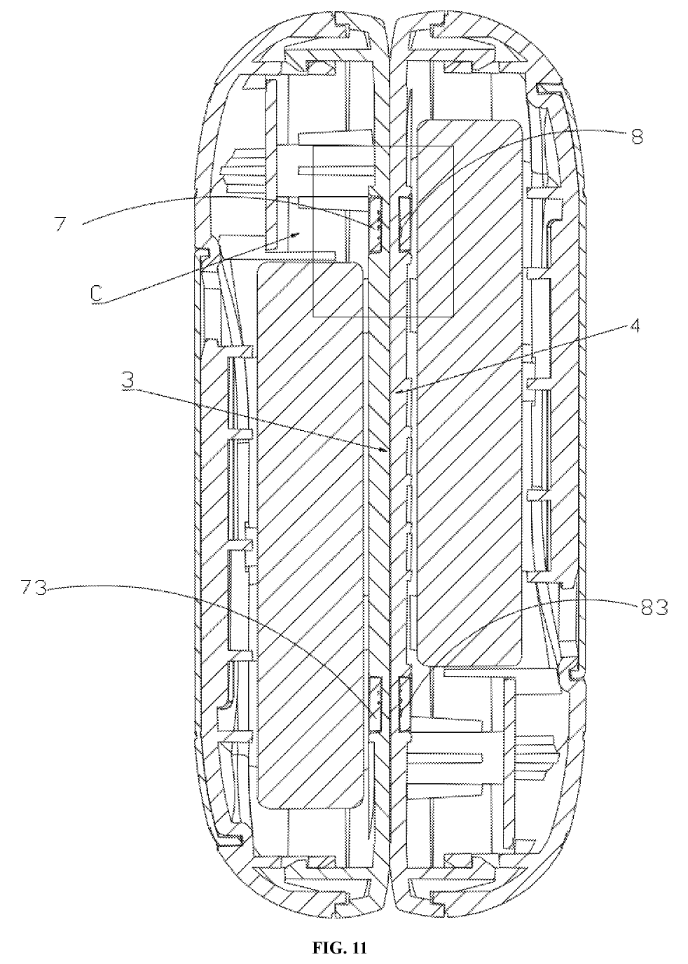

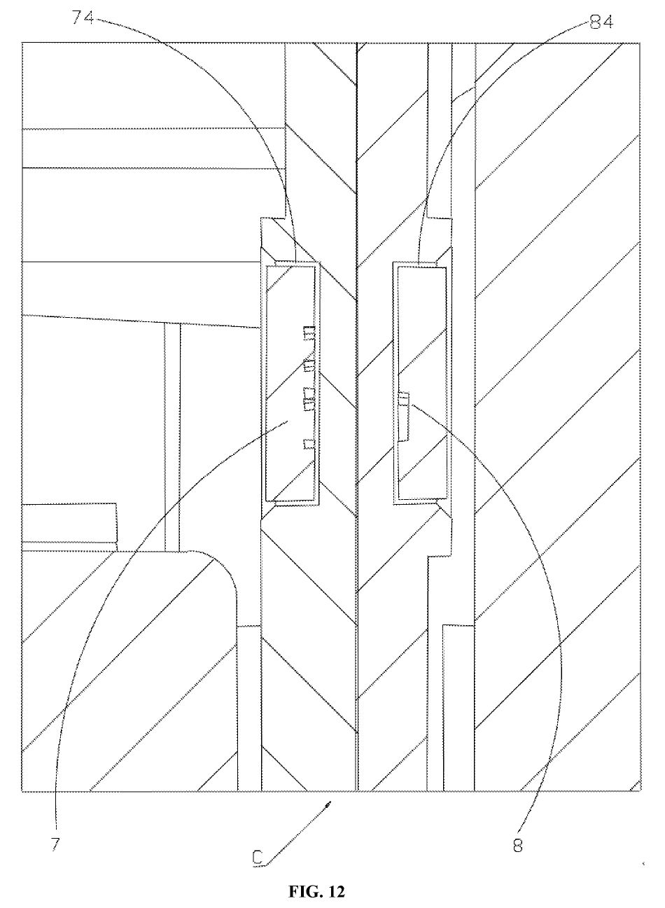

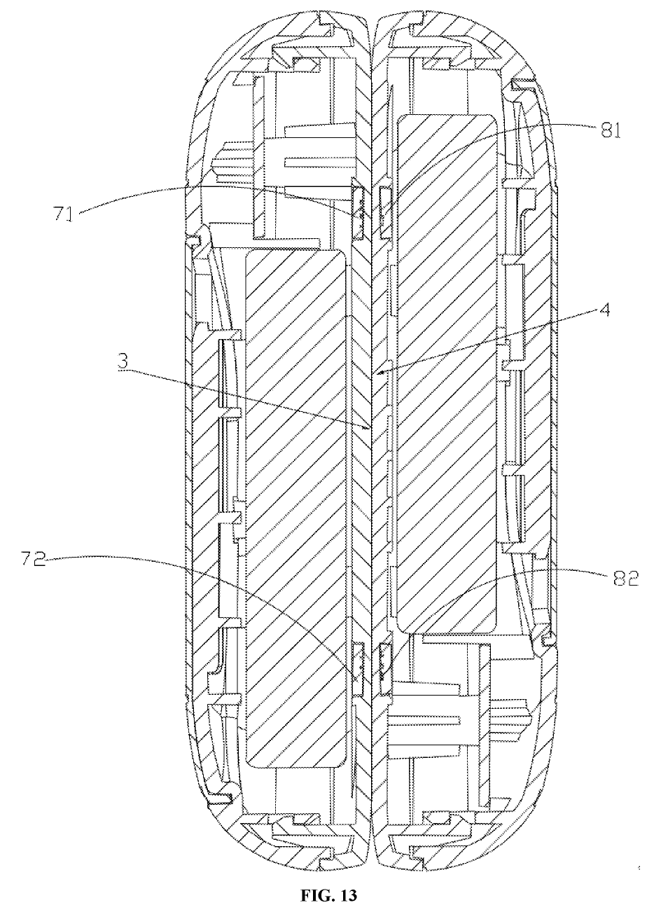

Referring to FIGS. 7-14, in some embodiments, the first connecting portion 3 and the second connecting portion 4 are magnetically connected; the first connecting portion 3 includes a first magnetic member 7 mounted in an inner side thereof; the second connecting portion 4 includes a first magnetic fitting piece 8 mounted in an inner side thereof; the first magnetic member 7 and the first magnetic fitting piece 8 are mutually sucked, so that the first connecting inner surface 15 is sucked on the second connecting inner surface 25. Specially, the first connecting inner surface 15 and the second connecting inner surface 25 are continuous (i.e., uninterrupted) surfaces without exposing the first magnetic member 7 and the first magnetic fitting piece 8, and the first magnetic member 7 and the first magnetic fitting piece 8 can suck each other through the first connecting inner surface 15 and the second connecting inner surface 25, thus the first hand warmer unit 1 and the second hand warmer unit 2 are combined into a whole.

In addition, except the above first magnetic member 7 and the first magnetic fitting piece 8, the first connecting portion 3 further includes a second magnetic fitting piece 71 mounted in the inner side thereof; the second connecting portion 4 further includes a second magnetic member 81 mounted in the inner side thereof; the second magnetic fitting piece 71 and the second magnetic member 81 are mutually sucked to suck the first connecting inner surface 15 onto the second connecting inner surface 25; and the first hand warmer unit 1 and the second hand warmer unit 2 are combined into a whole. Specifically, the first connecting portion 3 includes a third magnetic member 72; the second connecting portion 4 includes a third magnetic fitting piece 82; the third magnetic member 72 and the third magnetic fitting piece 82 are mutually sucked, so that the first connecting inner surface 15 is sucked to the second connecting inner surface 25, and the first hand warmer unit 1 and the second hand warmer unit 2 are combined into a whole. Furthermore, the first connecting portion 3 can further include a fourth magnetic fitting piece 73 mounted in the inner side thereof, and the second connecting portion 4 can further include a fourth magnetic member 83 mounted in the inner side thereof; and the fourth magnetic fitting piece 73 and the fourth magnetic member 83 are mutually sucked, so that the first connecting inner surface 15 is sucked to the second connecting inner surface 25, and the first hand warmer unit 1 and the second hand warmer unit 2 are combined into a whole.

Specially, the first connecting inner surface 15 further includes a first mounting hole 74; the second connecting inner surface 25 includes a second mounting hole 84; the first magnetic member 7 is arranged in the first mounting hole 74; the first magnetic fitting piece 8 is arranged in the second mounting hole 84; or, the first magnetic member is connected to the first connecting inner surface 15 through an adhesive; and the first magnetic fitting piece is connected to the second connecting inner surface 25 through an adhesive. The first magnetic member, the second magnetic member, the third magnetic member, and the fourth magnetic member can be magnets or magnetic metals. The first magnetic fitting piece, the second magnetic fitting piece, the third magnetic fitting piece, and the fourth magnetic fitting piece can be magnets or magnetic metals. When the first magnetic member, the second magnetic member, the third magnetic member, and the fourth magnetic member are magnets, the first magnetic fitting piece, the second magnetic fitting piece, the third magnetic fitting piece, and the fourth magnetic fitting piece are magnetic metals. When the first magnetic fitting piece, the second magnetic fitting piece, the third magnetic fitting piece, and the fourth magnetic fitting piece are magnets, the first magnetic member, the second magnetic member, the third magnetic member, and the fourth magnetic member are magnets or magnetic metals.

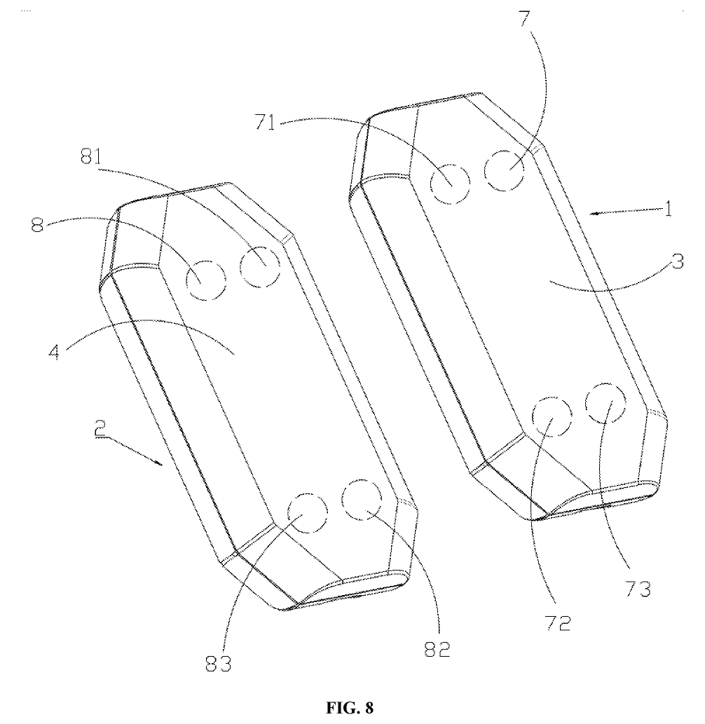

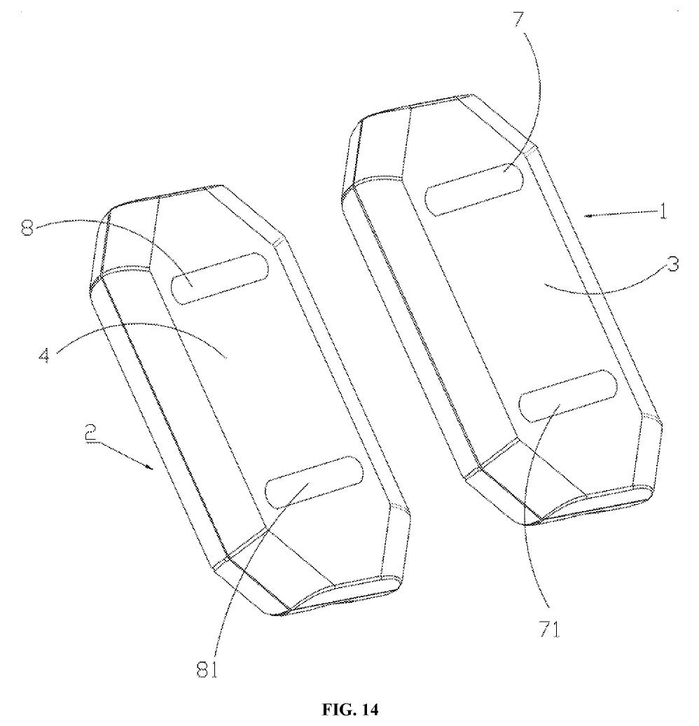

Referring to FIGS. 8 and 14, the first magnetic member, the second magnetic member, the third magnetic member, the fourth magnetic member, the first magnetic fitting piece, the second magnetic fitting piece, the third magnetic fitting piece, and the fourth magnetic fitting piece can be circular magnetic members and magnetic fitting pieces, or may be magnetic members and magnetic fitting pieces in another geometric shape such as ellipse or square. The first magnetic member 7 is circular or elliptical; a length range of the first magnetic member 7 is 5-25 mm; a width range of the first magnetic member 7 is 5-25 mm; the first magnetic fitting piece 8 is circular or elliptical; a length range of the first magnetic fitting piece 8 is 5-25 mm; a width range of the first magnetic fitting piece 8 is 5-25 mm; or, the first magnetic member 7 is elongated; a length range of the first magnetic member 7 is 10-30 mm; a width range of the first magnetic member 7 is 3-10 mm; the first magnetic fitting piece 8 is elongated; a length range of the first magnetic fitting piece 8 is 10-30 mm; and a width range of the first magnetic fitting piece 8 is 3-10 mm. Specifically, an area of the first magnetic member 7 accounts for 5% -20% of an area of the first connecting inner surface 15, and an area of the first magnetic fitting piece 8 accounts for 5% -20% of an area of the second connecting inner surface 25.

Through the above structure, the first magnetic member 7 is circular or elliptical; the length range of the first magnetic member 7 is 5-25 mm; the width range of the first magnetic member 7 is 5-25 mm; the first magnetic fitting piece 8 is circular or elliptical; the length range of the first magnetic fitting piece 8 is 5-25 mm; the width range of the first magnetic fitting piece 8 is 5-25 mm; or, the first magnetic member 7 is elongated; the length range of the first magnetic member 7 is 10-30 mm; the width range of the first magnetic member 7 is 3-10 mm; the first magnetic fitting piece 8 is elongated; the length range of the first magnetic fitting piece 8 is 10-30 mm; and the width range of the first magnetic fitting piece 8 is 3-10 mm. Specifically, the area of the first magnetic member 7 accounts for 5% -20% of the area of the first connecting inner surface 15, and the area of the first magnetic fitting piece 8 accounts for 5% -20% of an area of the second connecting inner surface 25. This makes the size and proportion design of the first magnetic member and the first magnetic fitting piece reasonable. The structure is simple, and the connection is stable, so that a magnetic suction force generated by the mutual magnetic suction between the first magnetic member and the first magnetic fitting piece can stably combine the first hand warmer unit 1 and the second hand warmer unit 2 into a whole, and a magnetic suction force generated by the mutual magnetic suction between the first magnetic member and the first magnetic fitting piece can effectively prevent the first hand warmer unit 1 from being separated from the second hand warmer unit. 2. It is convenient for a user to combine the first hand warmer unit 1 and the second hand warmer unit 2 into a whole for hand warming. Even if the user swings the combinable hand warmer during use, the first hand warmer unit 1 sand the second hand warmer unit 2 can be kept in a combined state, which greatly improves the user experience.

Referring to FIGS. 22-23, each of the hand warmer units further includes a battery 60. The battery 60 is located in the accommodating cavity 110 and is electrically connected to the circuit board 300. Each of the hand warmer units further includes a first heat insulation member 600. The first heat insulation member 600 is located between the first metal heat conduction shell 200 and the shell 100. Each of the hand warmer units further includes a second heat insulation member 700. The second heat insulation member 700 is located between the circuit board 300 and the battery 60 or between the battery 60 and the shell 100. By designing the first heat insulation member 600 and the second heat insulation member 700, the circuit board 300 and/or the battery 60 can be prevented from having an extremely high temperature due to the heat generated by the first metal heat conduction shell 200; the working safety of the circuit board 300 and/or the battery 60 is protected; and the safety of the hand warmer is improved. Materials of the first heat insulation member 600 and the second heat insulation member 700 include but are not limited to heat insulation foam, heat insulation silicone, heat insulation cold glue, and the like, and sizes and thicknesses can be set according to actual needs.

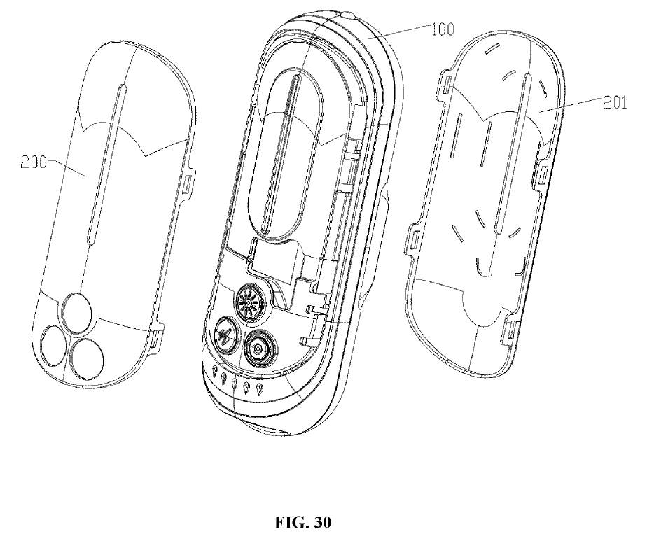

Referring to FIG. 30, each of the hand warmer units further includes a second metal heat conduction shell 201. The second metal heat conduction shell 201 is in snap-in connection with the shell 100 and is located on one side of the shell 100 facing away from the first metal heat conduction shell 200. The circuit board 300 is further electrically connected to the second metal heat conduction shell 201 to output an electrical signal to heat the second metal heat conduction shell 201. By designing the second metal heat conduction shell 201, two opposite surfaces of the hand warmer unit can generate heat simultaneously, thereby achieving higher warming efficiency and a better user experience.

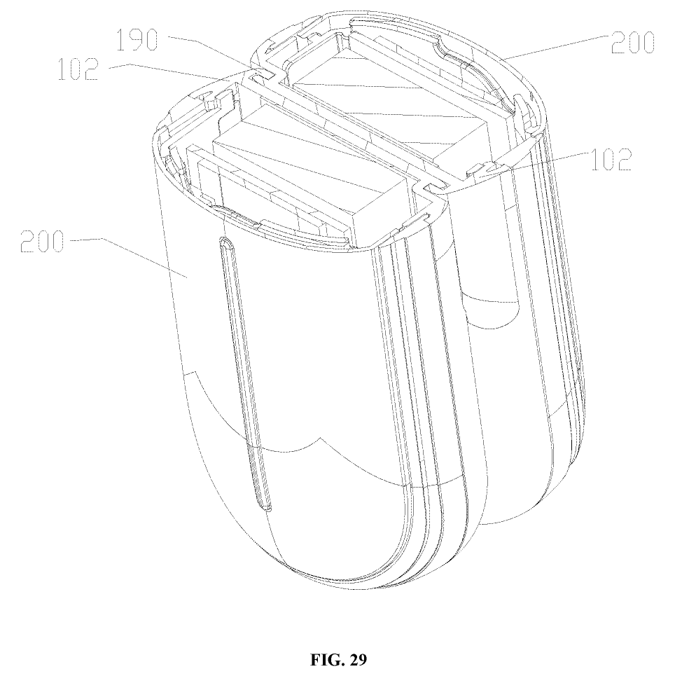

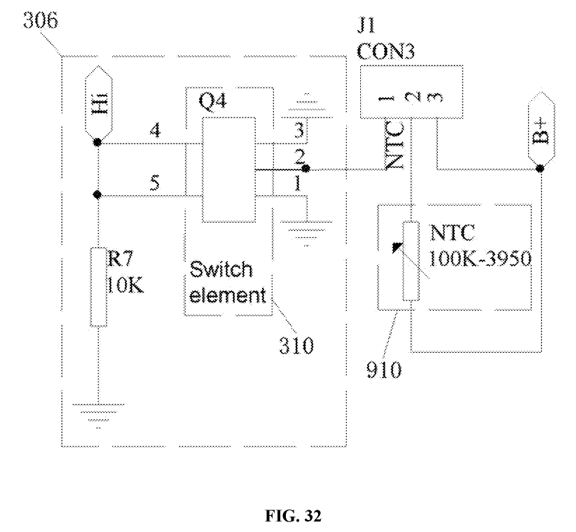

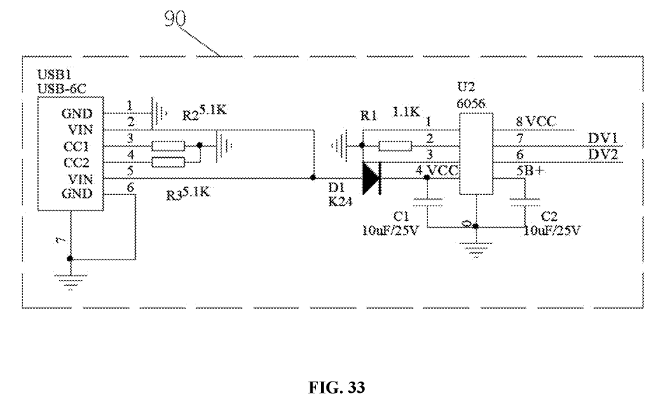

As shown in FIGS. 29-33, in this embodiment, the circuit board 300 of the hand warmer is equipped with a temperature control circuit, which includes a heating unit 306 for heating, at least one button unit 810, and a main control unit 301. The main control unit 301 is electrically connected to the button unit 810, and the main control unit 301 is electrically connected to the heating unit 306. The heating unit 306 includes at least one switching element 310 and a heating resistor R7; the switching element 310 is electrically connected to the main control unit 301, the ground terminal, and the heating resistor R7, respectively. The switching element 310 is a dual channel MOSFET Q4, and the heating unit 306 includes a dual channel MOSFET Q4 and a heating resistor R7.

A second terminal of the dual channel MOSFET Q4 is electrically connected to a control terminal of the main control unit 1. A first terminal and a third terminal of the dual channel MOSFET Q4 are grounded. A fourth terminal of the dual channel MOSFET Q4 is electrically connected to a drive terminal of the main control unit 1 and the heating resistor R7, respectively. A fifth terminal of the dual channel MOSFET Q4 is electrically connected to the drive terminal of the main control unit 1 and the heating resistor R7, respectively.

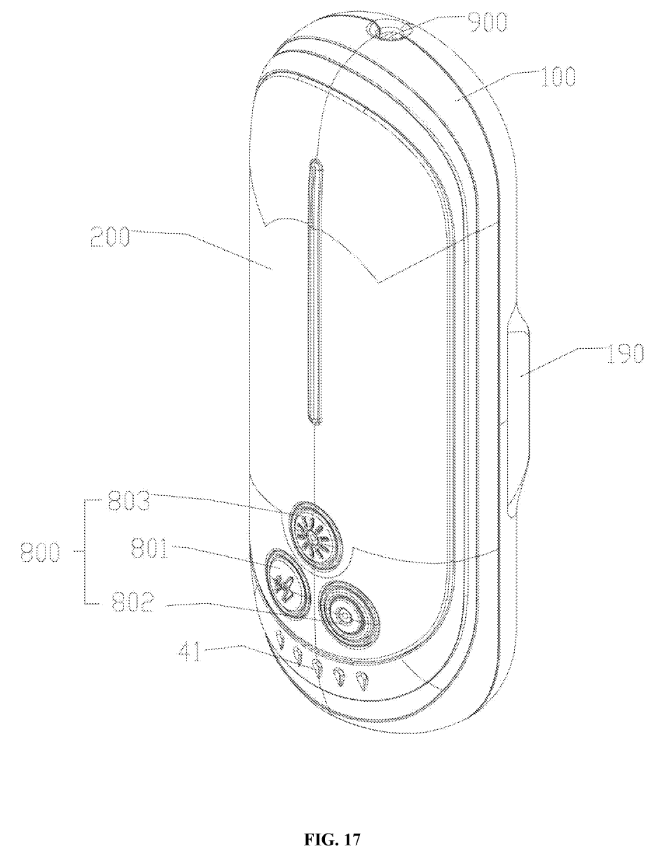

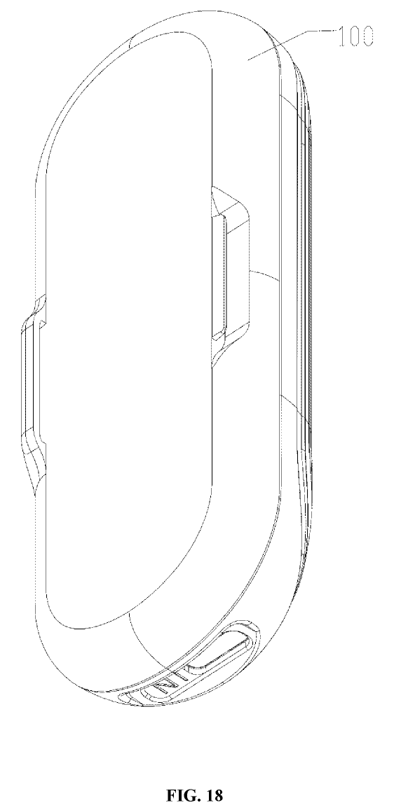

Referring to FIGS. 17-32, the hand warmer unit further includes a lamp 900, and the shell 100 is further provided with at least one operating unit 800. Further, the first metal heat conduction shell 200 has at least one first opening 230, the shell 100 has at least one second opening 180 corresponding to the at least one first opening 230. The at least one operating unit 800 is at least partially exposed via the at least one first opening 230 and the at least one second opening 180 for user operation.

The shell 100 is further provided with a lighting control button 803. The lamp 900 and the lighting control button 803 are electrically connected to the circuit board 300. The temperature control circuit of the hand warmer unit also includes a lighting unit 910, which is electrically connected to the main control unit 301. When the main control unit 301 receives a signal from the lighting control button 803, it outputs a lighting control signal to control the lighting unit 910 to illuminate. The lighting unit 910 includes an LED lamp D2 and a first resistor R6, a first end of the first resistor R6 is electrically connected to the main control unit 301, and a second end of the first resistor R6 is electrically connected to the anode of the LED lamp D2. The cathode of the LED lamp D2 is grounded.

The at least one operating unit 800 includes a first button 801 and a second button 802. Referring to FIG. 29, the button unit 810 corresponds to the operation unit 800, that is, the operation unit may include the button unit 810. The button unit 810 includes: a first button subunit 811, a second button subunit 812, and a third button subunit 813; the first button subunit 811 is electrically connected to the main control unit 301, and is used to output a first button signal based on the user's pressing operation. It can be understood that the first button subunit 811 corresponds to the first button 801; the second button subunit 812 is electrically connected to the main control unit 301, and is used to output a second button signal based on the user's pressing operation. It can be understood that the second button subunit 812 corresponds to the second button 802; the third button subunit 813 is used to output a third button signal based on user operation; it can be understood that the third button subunit 813 corresponds to the lighting control button 803.

As shown in FIG. 29, the temperature control circuit of the hand warmer unit also includes a first prompt unit 40, which is electrically connected to the main control unit 301 to prompt the user of the working temperature of the heating unit 306. Furthermore, the first prompt unit 40 are multiple indicator lights 410.

That is, the button unit 810 mentioned above corresponds to the operation unit 800, specifically, the first button subunit 811 corresponds to the first button 801 on the shell; the second button subunit 812 corresponds to the second button 802 on the shell; the third button subunit 813 corresponds to the lighting control button 803 on the shell, and the first prompt unit 40 is the multiple indicator lights 410 exposed on the shell 200.

Based on the specific operation logic of the button unit 810 and the indicator light 410 mentioned above, the main control unit 301 is used to turn on or off when it receives the first button signal or the second button signal reaching the preset time threshold. Specifically, when the user presses and holds the second button 802 (i.e., the second button subunit 812) for a preset time threshold, the main control unit 301 controls the power to turn on, lights up an indicator light 410, and controls the heating unit 306 to operate at the lowest temperature level. After each short press of the second button 802, the main control unit 301 controls the working temperature to gradually increase based on the number of times it receives the second button signal, and synchronously increases the number of indicator lights 410 that light up until the highest temperature of the highest gear is reached, then after another short press, it returns to the lowest temperature gear that lights up one indicator light for cycling.

When the user presses and holds the first button 801 (i.e. the first button subunit 811) for a preset time threshold, the main control unit 301 directly controls the power to turn on and quickly causes the heating unit 306 to reach the highest temperature working state, at this time, all indicator lights 410 are lit up. Short press the first button 801 in the highest temperature state, and the main control unit 301 will control the temperature to gradually decrease according to the received first button signal, and correspondingly reduce the number of indicator lights 410 lit. After reaching the lowest temperature, short press again to cycle back to the highest temperature, and all indicator lights will light up.

The above structure uses an independent dual button system of "one click low temperature, short press gradually heats up" and "one click high temperature, short press gradually cools down", which not only allows users to directly reach the highest temperature with one click in extreme cold environments, but also smoothly cools down according to changes in body sensation; by combining the intuitive and explicit feedback of multiple indicator lights, the blind spots in users' understanding of the current heating gear have been eliminated, greatly improving the accuracy of temperature regulation and the convenience of user interaction.

The main control unit 301 includes a plurality of set levels corresponding to multi-level temperature adjustment mode, each level is achieved through a duty cycle of a PWM signal. The main control unit 1 controls the driving power of the heating unit 306 by adjusting the duty cycle of the PWM signal, thereby adjusting the working temperature thereof.

The temperature control circuit of hand warmer unit also includes: a battery level detection unit 70, a sampling terminal of the battery level detection unit 70 is electrically connected to the battery 60, and an output terminal of the battery level detection unit 70 is electrically connected to the main control unit 301, used to detect the voltage of the battery energy and output a power detection signal to the main control unit 301. The temperature control circuit of the hand warmer unit also includes a second prompt unit 50, which is electrically connected to the main control unit 301 and used to prompt the user that the battery level is 60. The main control unit 301 controls the corresponding indicator light 410 to operate based on the received power detection signal. For example, multiple indicator lights 410 can be set as red and blue dual color lights, and the main control unit 301 controls the corresponding blue lights to display different numbers based on the battery level detection signal to indicate the remaining battery level.

The temperature control circuit of hand warmer also includes: a battery level detection unit 70, a sampling terminal of the battery level detection unit 70 is electrically connected to the battery 60, and an output terminal of the battery level detection unit 70 is electrically connected to the main control unit 301, used to detect the voltage of the battery energy and output a power detection signal to the main control unit 301. The temperature control circuit of the hand warmer also includes a second prompt unit 50, which is electrically connected to the main control unit 301 and used to prompt the user that the battery level is 60. The main control unit 301 controls the corresponding indicator light 410 to operate based on the received power detection signal. For example, multiple indicator lights 410 can be set as red and blue dual color lights, and the main control unit 301 controls the corresponding blue lights to display different numbers based on the battery level detection signal to indicate the remaining battery level.

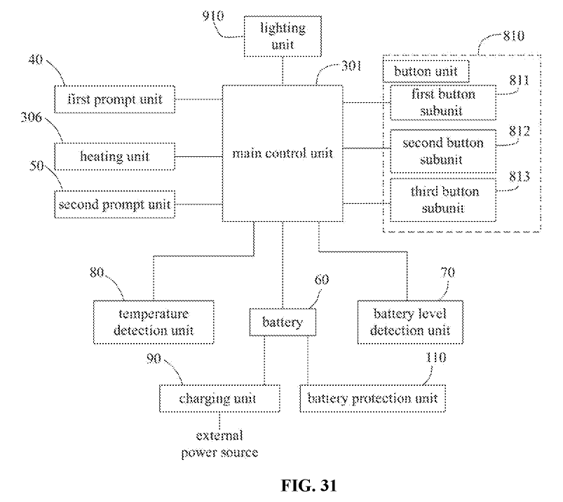

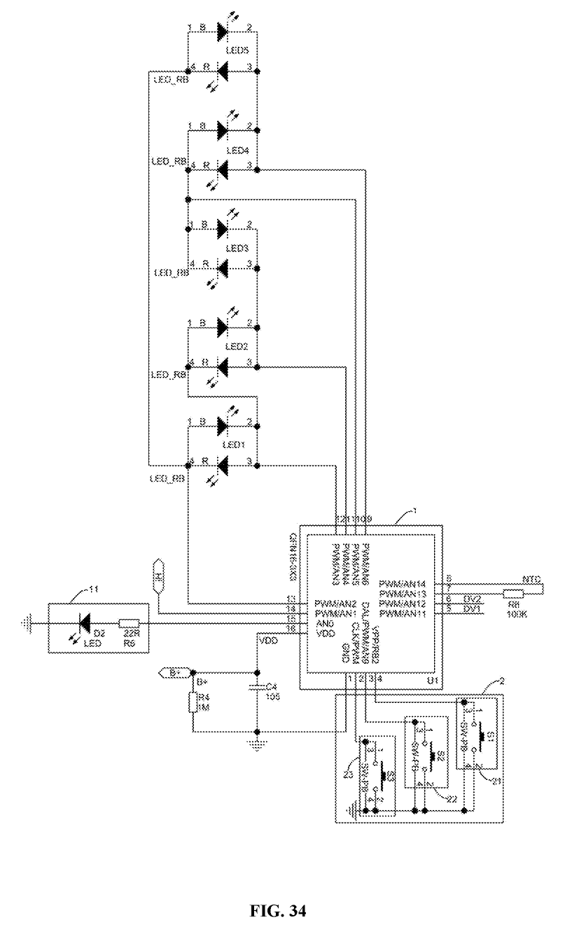

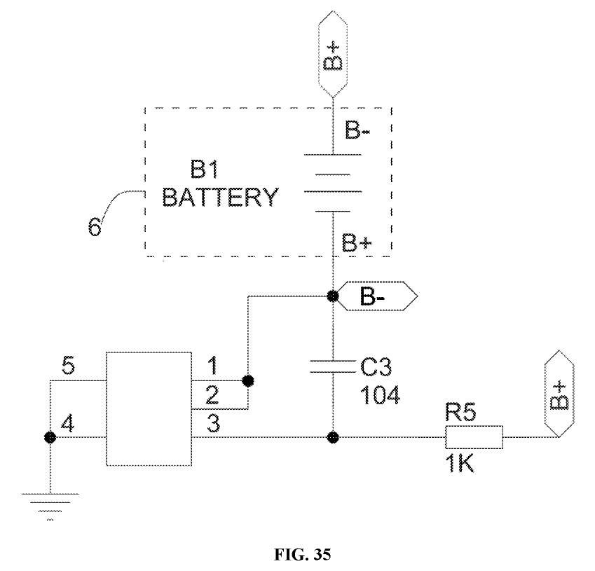

The temperature control circuit of the hand warmer unit also includes a temperature detection unit 80, a charging unit 90, and a battery protection unit 110. Specifically, as shown in FIGS. 30-35, the temperature detection unit 80 is specifically an NTC resistor, which is connected to the circuit between the battery 60 and the connector CON3. When the main control unit 301 detects that the temperature of the battery 60 is too high, it stops the battery 60 from outputting battery power. As shown in FIG. 31, the input terminal of the charging unit 90 is connected to an external power source, and the output terminal is electrically connected to the battery 60, used to convert the voltage of the connected external power source to output charging energy to charge the battery 60; specifically, the charging unit 90 is implemented by a USB port and a power management chip U2. The battery protection unit 110 is set between the positive and negative poles of the battery 60 to prevent overcharging, overdischarging, and short circuiting of the battery 60.

It can be understood that both the first hand warmer unit 1 and the second hand warmer unit 2 in this embodiment can be used as independent hand warmers after separation. Therefore, the first hand warmer unit 1 and the second hand warmer unit 2 are independently equipped with the same operating unit 800, the first prompt unit 40, and the charging ports 11, 21 on their respective shells 200, 100, and the battery 60 and the circuit board 300 are independently configured in their respective storage cavities 111.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. A combinable hand warmer, comprising a first hand warmer unit (1) and a second hand warmer unit (2), wherein the first hand warmer unit (1) comprises a first outer surface (14) and a first connecting inner surface (15) opposite to the first outer surface (14); the second hand warmer unit comprises a second outer surface (24) and a second connecting inner surface (25) opposite to the second outer surface (24); the first connecting inner surface (15) comprises a first connecting portion (3); the second connecting inner surface (25) comprises a second connecting portion (4); and the first connecting portion (3) and the second connecting portion (4) are connected to each other through a buckle or a plurality of magnetic components; and to connect the first connecting inner surface (15) to the second connecting inner surface (25), the first hand warmer unit (1) and the second hand warmer unit (2) are combined into a whole;
wherein each of the first hand warmer unit (1) and the second hand warmer unit (2) is plate-shaped and comprises a width, length, and thickness, the thickness being less than the length and the width of the respective hand warmer unit, and the first hand warmer unit (1) and the second hand warmer unit (2) are combined into a whole by stacking in an up and down manner along a direction of the thickness; wherein a first outer surface (14) of the first hand warmer unit (1) and a second outer surface (24) of the second hand warmer unit (2) are each defined by their respective length and width, each serving as a complete warming surface; whereby the combination of the first hand warmer unit (1) and the second hand warmer unit (2) provides a total warming surface area comprised of the first and second outer surfaces (14, 24), the portion of each outer surface (14, 24) configured to contact a user's palm remaining substantially the same whether the units (1, 2) are attached or detached.

2. The combinable hand warmer according to claim 1, wherein each of the first hand warmer unit (1) and a second hand warmer unit (2) comprises a shell (100) and a first metal heat conduction shell (200), the first metal heat conduction shell (200) is in snap in connection with the shell (100) and is located on an outer side of the shell (100) at the direction of the thickness;
wherein the first metal heat conduction shell (200) comprises a metal plate (210) and at least one first fastener (220) connected to the metal plate (210); and the at least one first fastener (220) is integrally formed with the metal plate (210), and at least one second fastener (130) is arranged on an inner side of the shell (100), the at least one first fastener (220) is clamped with the at least one second fastener (130), thereby the shell (100) is connected to the first metal heat conduction shell (200).

3. The combinable hand warmer according to claim 2, wherein the shell (100) is provided with an elastic portion (140) and a U-shaped fixing hole (120), which wraps around the elastic portion (140), so that one end of the elastic portion (140) is connected to the shell (100), and the other end forms a freely movable elastic end, the at least one first fastener (220) is clamped with the at least one second fastener (130) by abutting the at least one elastic portion (140).

4. The combinable hand warmer according to claim 3, wherein the fixing hole (120) comprises a main body (121) for the at least one first fastener (220) penetrating through, and two extension portions (122) that are continuous with the main body (121) and located at opposite ends thereof, the elastic portion (140) extends towards one end of the main body (121) with an arc-shaped guide portion (141), so that the at least one first fastener (220) slides along the arc-shaped guide portion (141) during insertion and forces the elastic portion (140) to produce elastic retreat towards the inner side of the shell (100).

5. The combinable hand warmer according to claim 4, wherein the arc-shaped guide portion (141) extends and transitions to form a groove portion (142), the groove portion (142) is spaced apart from the second fastener (130) on the shell (100) to jointly define a locking space, the at least one first fastener (220) is clamped with the at least one second fastener (130) in the locking space, and at least part of the at least one first fastener (220) in located in the groove portion (142).

6. The combinable hand warmer according to claim 2, wherein the at least one first fastener (220) includes a clamping slot (221) provided on the metal plate (210), and the at least one second fastener (130) includes a hook (131) corresponding to the clamping slot (221), which is fixed inside the clamping slot (221).

7. The combinable hand warmer according to claim 2, wherein the shell (100) comprises an accommodating cavity (111), each of the first hand warmer unit (1) and the second hand warmer unit (2) further include a circuit board (300), a battery (60) and a heating element (400), the circuit board (300) and the battery (60) are arranged in the accommodating (111), the heating element (400) is arranged on the shell (100) facing the first metal heat conduction shell (200), the circuit board (300) is electrically connected to the heating element (400) and used to control the heating of the heating element (400);
the shell (100) is provided with an operation unit (800) and a first prompt unit (40), the operation unit (800) is exposed on the first metal heat conduction shell (200), and comprises a first button (801) and a second button (802), the first button (801), the second button (802) and the first prompt unit (40) are all electrically connected to the circuit board (300), the circuit board (300) is configured to electrically connect the heating element (400) and/or the first metal heat conduction shell (200), and the circuit board (300) is used to output electrical signals to heat the heating element (400) and/or the first metal heat conduction shell (200).

8. The combinable hand warmer according to claim 7, wherein the first prompt unit (40) includes a plurality of indicator lights (410), the circuit board (300) is configured to control power on or off when receiving a first press operation on the second button (802) reaching a first preset time threshold;
the circuit board (300) is further configured to control a heating temperature to a lowest temperature level and light up one of indicator lights (410) when the power is turned on;
the circuit board (300) is further configured to control the heating temperature to rise by levels and correspondingly increase a number of the indicator lights (410) lit up when receiving a second press operation on the second button (802) reaching a second preset time threshold less than the first preset time threshold; and
the circuit board (300) is further configured to control the heating temperature to return to the lowest temperature level for cyclic adjustment of the heating temperature when the heating temperature reaches a highest temperature level and the second press operation is received again.

9. The combinable hand warmer according to claim 7, wherein the first prompt unit (40) includes a plurality of indicator lights (410), the circuit board (300) is configured to control power on or off when receiving a first press operation on the first button (801) reaching a first preset time threshold;
the circuit board (300) is further configured to control a heating temperature to a highest temperature level and light up all the indicator lights (410) when the power is turned on;
the circuit board (300) is further configured to control the heating temperature to gradually decrease and correspondingly reduce a number of the indicator lights (410) lit up when receiving a second press operation on the first button (801) reaching a second preset time threshold less than the first preset time threshold; and
the circuit board (300) is further configured to control the heating temperature to return to the highest temperature level for cyclic adjustment when the heating temperature reaches a lowest temperature level and the second press operation is received again.

10. The combinable hand warmer according to claim 7, wherein the hand warmer further comprises a lighting lamp (900), and the operating unit (800) further comprises a lighting control button (803), the lighting lamp (900) and the lighting control button (803) are electrically connected to the circuit board (300); the circuit board (300) is configured to control the lighting lamp (900) to turn on or off when receiving a press operation on the lighting control button (803) reaching a preset time threshold.

11. The combinable hand warmer according to claim 1, wherein the first connecting portion (3) and the second connecting portion (4) are connected to each other through a buckle, and the first connecting portion (3) includes a first buckle portion (31); the second connecting portion (4) includes a first buckle fitting portion (41); the first buckle portion (31) is detachably connected to the first buckle fitting portion (41), so that the first connecting inner surface (15) is buckled to the second connecting inner surface (25), and the first hand warmer unit (1) and the second hand warmer unit (2) are combined into a whole.

12. The combinable hand warmer according to claim 11, wherein the first connecting portion (3) further includes a first positioning column (33), and the second connecting portion (4) further includes a first positioning hole (43); and when the first positioning column (33) is located in the first positioning hole (43), the first buckle portion (31) is detachably plugged into the first buckle fitting portion (41).

13. The combinable hand warmer according to claim 2, wherein the shell (100) is made of plastic material, a hardness of the shell (100) is lower than that of the first metal heat conduction shell (200); a thermal conductivity of the shell (100) is lower than that of the first metal heat conduction shell (200).

14. The combinable hand warmer according to claim 7, wherein each of the first hand warmer unit (1) and the second hand warmer unit (2) further includes a first insulation member (600) and a second insulation member (700), wherein the first insulation member (600) is located between the first metal heat conduction shell (200) and the shell (100); the second insulation member (700) is located between the circuit board (300) and the battery (60), or located between the battery (60) and the shell (100).

15. The combinable hand warmer according to claim 8, wherein each of the first hand warmer unit (1) and the second hand warmer unit (2) includes a power detection unit (70), which detects a voltage of the battery (60) and outputs a power detection signal to the circuit board (300); the circuit board (300) is configured to control the indicator lights (410) based on the power detection signal to display a power level by changing a number of lights on.

16. The combinable hand warmer according to claim 7, wherein the heating element (400) is attached to an inner side of the first metal heat conduction shell (200), and is selected from at least one of metal heating plates, flexible heating circuit boards, or heating film layers.

17. The combinable hand warmer according to claim 1, wherein the first connecting portion (3) and the second connecting portion (4) are connected to each other through a plurality of magnetic components, and the magnetic components include a first magnetic member (7) located inside the first connecting inner surface (15) and a first magnetic fitting piece (8) located inside the second connecting inner surface (25);
the first connecting inner surface (15) is also provided with a first mounting hole (74), and the first magnetic member (7) is fixed in the first mounting hole (74) by adhesive or interference fit.

18. The combinable hand warmer according to claim 17, wherein the first magnetic member (7) is circular or elliptical; a length range of the first magnetic member (7) is 5-25 mm; a width range of the first magnetic member (7) is 5-25 mm; the first magnetic fitting piece (8) is circular or elliptical; a length range of the first magnetic fitting piece (8) is 5-25 mm; a width range of the first magnetic fitting piece (8) is 5-25 mm; or, the first magnetic member (7) is elongated; a length range of the first magnetic member (7) is 10-30 mm; a width range of the first magnetic member (7) is 3-10 mm; the first magnetic fitting piece (8) is elongated; a length range of the first magnetic fitting piece (8) is 10-30 mm; and a width range of the first magnetic fitting piece (8) is 3-10 mm.

19. The combinable hand warmer according to claim 1, wherein the first connecting portion (3) and the second connecting portion (4) are connected to each other through a plurality of magnetic components, and the plurality of magnetic components cooperatively account for 5% -20% of an area of the first connecting inner surface (15), and the plurality of magnetic components cooperatively account for 5%-20% of an area of the second connecting inner surface (25).

20. The combinable hand warmer according to claim 1, wherein the first connecting portion (3) and the second connecting portion (4) are connected to each other through a plurality of magnetic components, and the first connecting inner surface (15) and the second connecting inner surface (25) are uninterrupted without exposed elements.
